(19) United States
(12) Patent Application Publication
(10) Pub. No.: US 2006/0001638 A1
(43) Pub. Date: Jan. 5, 2006

(54) TFT substrate, display device having the same and method of driving the display device

(76) Inventors: Jin Jeon, Suwon-si (KR); Bo-Young An, Yongin-si (KR)

Correspondence Address: CANTOR COLBURN, LLP, 55 GRIFFIN ROAD SOUTH, BLOOMFIELD, CT, 06002, US

(21) Appl. No.: 11/173,846

(22) Filed: Jul. 1, 2005

(30) Foreign Application Priority Data
Jul. 5, 2004 (KR) 2004-51899

(51) Int. Cl. G09G 3/36

(52) U.S. Cl. 345/100

(57) ABSTRACT

A TFT substrate includes data lines, scan lines, pixels and a shift register. The data lines are extended along a first direction. The scan lines are extended along a second direction that is substantially perpendicular to the first direction. Each of the pixels is defined by a selected data line and a selected scan line. The shift register has stages electrically coupled with each other. An output terminal of a (4K−3)-th stage is electrically connected to a (4K−3)-th scan line, an output terminal of a (4K−2)-th stage is electrically connected to a (4K−1)-th scan line, an output terminal of a (4K−1)-th stage is electrically connected to a (4K−2)-th scan line, and a 4K-th stage is electrically connected to a 4K-th scan line, wherein ‘K’ represents a natural number. Therefore, a 1-line inversion may be accomplished by using a common voltage having a 4H time period to reduce power consumption of a display device.

This application claims priority to Korean Patent Application No. 2004-51899 filed on Jul. 5, 2004, and all the benefits accruing therefrom under 35 U.S.C §119, and the contents of which in its entirety are herein incorporated by reference.

### BACKGROUND OF THE INVENTION

1. Field of the Invention

The present invention relates to a thin film transistor (TFT) substrate, a display device having the TFT substrate and a method of driving the display device. More particularly, the present invention relates to a TFT substrate capable of reduced power consumption, a display device having the TFT substrate and a method of driving the display device.

2. Description of the Related Art

A liquid crystal display (LCD) device includes an LCD panel displaying images, and a driving section driving the LCD panel. The LCD panel includes a TFT substrate (or a lower substrate), a color filter substrate (or an upper substrate) and a liquid crystal layer disposed between the TFT substrate and the color filter substrate.

The TFT substrate includes pixels defined by data lines extended in a first direction and scan lines extended in a second direction that is substantially perpendicular to the first direction. Each of the pixels includes a switching device, a liquid crystal capacitor and a storage capacitor. The switching device includes a gate electrode that is electrically connected to one of the scan lines, a source electrode that is electrically connected to one of the data lines, and a drain electrode that is electrically connected to a first electrode (or a pixel electrode). The storage capacitor is defined by the gate electrode and the pixel electrode. The color filter substrate includes color filters and a common electrode (or a second electrode). When a pixel voltage is applied to the pixel electrode, electric fields are generated between the pixel electrode of the TFT substrate and the common electrode of the color filter substrate. In response to changes in the electric fields that are applied to the liquid crystal layer disposed between the pixel electrode and the common electrode, an arrangement of liquid crystal molecules of the liquid crystal layer is changed to alter optical transmittance, so that images are displayed.

When electric fields having a fixed direction are applied to the liquid crystal layer continuously, the liquid crystal molecules suffer a gradual failure. Therefore, in order to prevent the gradual failure of the liquid crystal molecules, a polarity of a pixel voltage that is applied to the pixel electrode is changed in order to change a direction of electric fields generated between the pixel electrode and the common electrode.

For example, an LCD device may employ a frame inversion method, a 1-line inversion method, etc. According to the frame inversion method, a level of the pixel voltage is changed each frame. According to the 1-line inversion method, a polarity of the pixel voltage is changed each scan line. For example, according to the 1-line inversion method, a voltage level applied to the common electrode is changed every 1H and a level of the pixel voltage is changed with respect to a level of the common voltage. The time 1H corresponds to a time period for activating one scan line, and the time 1H is expressed as following Expression 1.

### Expression 1

1H=1/f×1/(a number of scan lines),

wherein ‘f’ represents a driving frequency.

For example, when the driving frequency ‘f’ is 60 Hz, and resolution is XGA (1024×768), the 1H is 1/60×1/768≈21.7 μs.

When the resolution increases, an inversion frequency of the common voltage level also increases. When the inversion frequency of the common voltage increases, power consumption of the LCD device increases.

### SUMMARY OF THE INVENTION

The present invention provides a TFT substrate capable of reduced power consumption. The present invention also provides a display device having the TFT substrate. The present invention also provides a method of driving the display device.

In an example of a TFT substrate according to the present invention, the TFT substrate includes data lines, scan lines, pixels and a shift register. The data lines are extended along a first direction. The scan lines are extended along a second direction that is substantially perpendicular to the first direction. Each of the pixels is defined by a selected data line and a selected scan line, and has a switching device electrically connected to the selected data line and the selected scan line. The shift register has stages electrically coupled with each other. An output terminal of a (4K−3)-th stage is electrically connected to a (4K−3)-th scan line, an output terminal of a (4K−2)-th stage is electrically connected to a (4K−1)-th scan line, an output terminal of a (4K−1)-th stage is electrically connected to a (4K−2)-th scan line, and a 4K-th stage is electrically connected to a 4K-th scan line. ‘K’ represents a natural number.

In an example of a display device according to the present invention, the display device includes a display section, a voltage generating section, a first driving section and a second driving section. The display section includes data lines, scan lines, a switching device electrically connected to one of the data lines and one of the scan lines, and a liquid crystal capacitor. The liquid crystal capacitor has a first terminal electrically connected to the switching device and a second terminal receiving a common voltage. The voltage generating section outputs the common voltage having a first level during a first time period, and outputs the common voltage having a second level during a second time period. The first driving section applies data signals corresponding to a (4K−3)-th scan line and a (4K−1)-th scan line in sequence during the first time period, and applies data signals corresponding to a (4K−2)-th scan line and a 4K-th scan line in sequence during the second time period. The second driving section outputs scan signals activating the (4K−3)-th scan line and the (4K−1)-th scan line in sequence and then outputs scan signals activating the (4K−2)-th scan line and the 4K-th scan line in sequence. ‘K’ represents a natural number.

In an example of a driver device configured to drive a display device having data lines, scan lines, a switching device electrically connected to one of the data lines and one of the scan lines, and a liquid crystal capacitor having a first terminal electrically connected to the switching device and a second terminal receiving a common voltage according to the present invention, the driver device includes a voltage generating section, a first driving section and a second driving section. The voltage generating section outputs the common voltage having a first level during a first time period, and outputs the common voltage having a second level during a second time period. The first driving section applies data signals corresponding to a (4K−3)-th scan line and a (4K−1)-th scan line in sequence during the first time period, and applies data signals corresponding to a (4K−2)-th scan line and a 4K-th scan line in sequence during the second time period. The second driving section outputs scan signals activating the (4K−3)-th scan line and the (4K−1)-th scan line in sequence and then outputs scan signals activating the (4K−2)-th scan line and the 4K-th scan line in sequence. ‘K’ represents a natural number.

In an example of a method for driving a display device having data lines, scan lines, a switching device electrically connected to one of the data lines and one of the scan lines, and a liquid crystal capacitor having a first terminal electrically connected to the switching device and a second terminal, a (4K−3)-th scan line and a (4K−1)-th scan line are activated in sequence while a data signal having a reference level corresponding to a second level that is opposite to a first level is applied to the data lines during a first time period when a common voltage having the first level is applied to the second terminal of the liquid crystal capacitor. A (4K−2)-th scan line and a 4K-th scan line are activated in sequence while a data signal having a reference level corresponding to the first level is applied to the data lines during a second time period when a common voltage having the second level is applied to the second terminal of the liquid crystal capacitor.

In another example of a method for driving a display device having data lines, scan lines, a switching device electrically connected to one of the data lines and one of the scan lines, and a liquid crystal capacitor having a first terminal electrically connected to the switching device and a second terminal, a common voltage having a 4H time period is applied to the second terminal of the liquid crystal capacitor. A data signal having a reference level corresponding to a second level that is opposite to a first level is applied to the data lines during a first 2H time period when the common voltage has the first level. A (4K−3)-th scan line and a (4K−1)-th scan line are activated in sequence during the first 2H time period. A data signal having a reference level corresponding to the first level is applied to the data lines during a second 2H time period when the common voltage has the second level. A (4K−2)-th scan line and a 4K-th scan line are activated in sequence during the first 2H time period. ‘K’ represents a natural number.

According to the present invention, a 1-line inversion may be accomplished by using the common voltage having a 4H time period to reduce power consumption of a display device in comparison with a conventional 1-line inversion using the common voltage having a 2H inversion. An LCD device according to the present invention is more useful, when the LCD device is employed by a portable device that is operated by a battery, such as a notebook computer, etc.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a schematic block diagram illustrating an LCD device according to an exemplary embodiment of the present invention;

FIG. 2 is a block diagram illustrating a driver section in FIG. 1;

FIG. 3 is a block diagram illustrating a data driving section in FIG. 2;

FIG. 4 is a block diagram illustrating a scan driving section in FIG. 1;

FIG. 5 is a block diagram illustrating a unit stage in FIG. 4;

FIG. 6 is a layout illustrating an electrical connection between output terminals of the scan driving section and scan lines in a display section in FIG. 1;

FIG. 7 is a cross-sectional view taken along line I-I′ in FIG. 6;

FIG. 8 is a timing diagram illustrating input signals and output signals of the LCD device in FIG. 1;

FIG. 9 is a schematic block diagram illustrating an LCD device according to an exemplary embodiment of the present invention;

FIG. 10 is a block diagram illustrating a driver section in FIG. 9;

FIG. 11 is a block diagram illustrating a first scan driving section and a second driving section in FIG. 9;

FIG. 12 is a schematic block diagram illustrating an LCD device according to another exemplary embodiment of the present invention;

FIG. 13 is a block diagram illustrating a data driving section in FIG. 12;

FIG. 14 is a timing diagram illustrating input signals and output signals of the LCD device in FIG. 12;

FIG. 15 is a schematic block diagram illustrating an LCD device according to another exemplary embodiment of the present invention;

FIG. 16 is a schematic block diagram illustrating an LCD device according to yet another exemplary embodiment of the present invention; and

FIG. 17 is a schematic block diagram illustrating an LCD device according to still another exemplary embodiment of the present invention.

### DETAILED DESCRIPTION OF THE INVENTION

It should be understood that the exemplary embodiments of the present invention described below may be varied or modified in many different ways without departing from the inventive principles disclosed herein, and the scope of the present invention is therefore not limited to these particular flowing embodiments. Rather, these embodiments are provided so that this disclosure will be thorough and complete, and will fully convey the concept of the invention to those skilled in the art by way of example and not of limitation.

Hereinafter exemplary embodiments of the present invention will be described in detail with reference to the accompanied drawings.

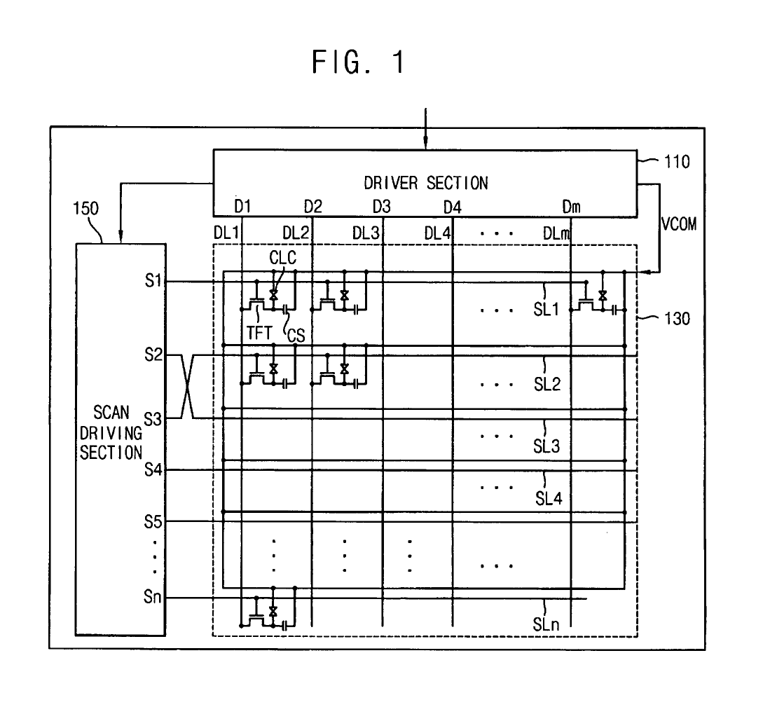

FIG. 1 is a schematic block diagram illustrating a liquid crystal display (LCD) device according to an exemplary embodiment of the present invention. The LCD device according to the present embodiment employs a 1-line inversion with reference to a common voltage having a 4H period in which H corresponds to a time period for activating one scan line.

Referring to FIG. 1, an LCD device includes a driver section 110, a display section 130 and a scan driving section 150. The driver section 110 controls the LCD device responsive to a first image signal and a first control signal provided by an external device. The display section 130 includes data lines DL1, DL2, . . . , DLm, and scan lines SL1, SL2, . . . , SLn.

The driver section 110 provides the display section 130 with a data signal and a common voltage VCOM. The driver section 110 also provides the scan driving section 150 with a control signal.

For example, the driver section 110 applies data signals D1, D2, . . . , Dm responsive to a second level of the common voltage VCOM to the data lines DL1, DL2, . . . , DLm for a first time period 2H, and the driver section 110 applies data signals responsive to a first level of the common voltage VCOM to the data lines DL1, DL2, . . . , DLm for a next time period 2H. The first level may be positive or negative, and the second level is opposite to the first level.

The driver section 110 controls the scan driving section 150 such that a (4K−3)-th scan line and a (4K−1)-th scan line are activated in sequence for a first time period 2H, and a (4K−2)-th scan line and a 4K-th scan line are activated in sequence for a next time period 2H.

Each of the data lines DL1, DL2, . . . , DLm is substantially perpendicular to each of the scan lines SL1, SL2, . . . , SLn. One of the data lines DL1, DL2, . . . , DLm and one of the scan lines SL1, SL2, . . . , SLn define a pixel, so that m×n (m times n) number of pixels are defined on the display section. Each pixel includes a switching device such as a thin film transistor (TFT), a liquid crystal capacitor CLC and a storage capacitor CS.

The TFT includes a gate electrode that is electrically connected to one of the scan lines SL1, SL2, . . . , SLn, a source electrode that is electrically connected to one of the data lines DL1, DL2, . . . , DLm, and a drain electrode electrically connected to a pixel electrode that corresponds to a first electrode of the liquid crystal capacitor CLC.

The common voltage VCOM outputted from the driver section 110 is applied to a common electrode that corresponds to a second electrode of the liquid crystal capacitor CLC. The common voltage has a time period of 4H.

The scan driving section 150 applies scan signals S1, S2, . . . , Sn to the scan lines SL1, SL2, . . . , SLn in sequence responsive to the control signal provided by the driver section 110. For example, the scan driving section 150 applies a (4K−3)-th scan signal (for example, S1) to a (4K−3)-th scan line (for example, SL1), and the scan driving section 150 applies a (4K−2)-th scan signal (for example, S2) to a (4K−1)-th scan line (for example, SL3), wherein ‘K’ represents a natural number. The scan driving section 150 applies a (4K−1)-th scan signal (for example, S3) to a (4K−2)-th scan line (for example, SL2), and the scan driving section 150 applies a 4K-th scan signal (for example, S4) to a 4K-th scan line (for example, SL4).

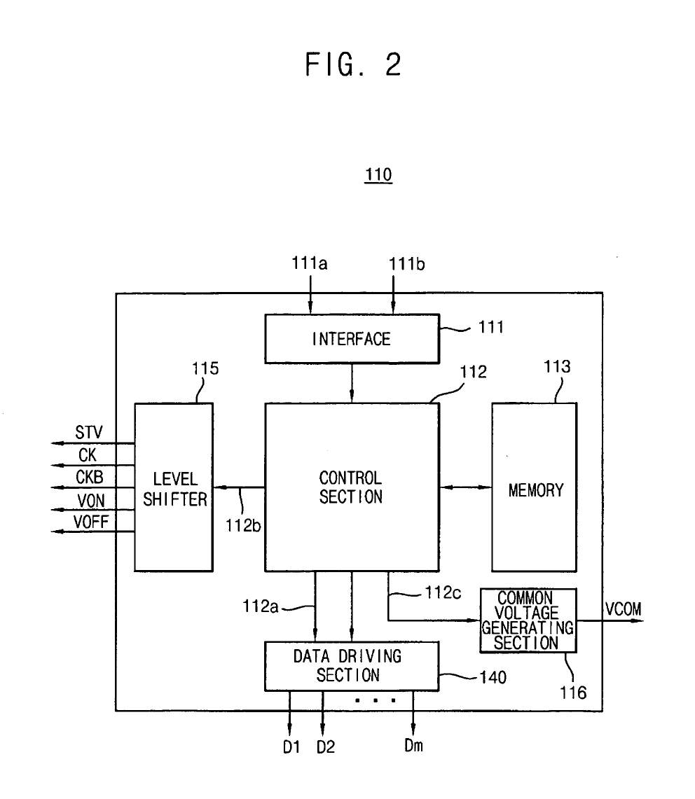

FIG. 2 is a block diagram illustrating a driver section in FIG. 1.

Referring to FIG. 2, the driver section 110 includes an interface 111, a control section 112, a memory 113, a data driving section 140, a level shifter 115 and a common voltage generating section 116.

The interface 111 interfaces a first image signal 111a and a first control signal 111b to the control section 112. The interface 111 is compatible with a CPU-interface, a video graphics board (VGB), a media-Q interface, etc.

The control section 112 transforms the first image signal 111a to a second image signal that is compatible with the data driving section 140, and the control section 112 also outputs a second control signal 112a, a third control signal 112b and a fourth control signal 112c responsive to the first control signal 111b. The first control signal 111b includes a horizontal synchronization signal HSYNC, a vertical synchronization signal VSYNC, a main clock signal MCK and a data enable signal DE. The second control signal 112a corresponds to a signal for controlling the data driving section 140. The second control signal 112a includes a horizontal start signal STH, a load signal TP and an inversion signal RVS. The third control signal 112b corresponds to a signal for controlling the level shifter 115. The fourth control signal 112c corresponds to a signal for controlling the common voltage generating section 116. The common voltage generating section is controlled such that a period of the common voltage VCOM is 4H.

The control section 112 also controls the memory 113 to write the first image signal 111a to the memory 113, and controls the memory 113 to read the first image signal 111a that is stored by the memory 113. The control section 112 reads the first image signal 111a having an inverted reference level with respect to the common voltage VCOM.

During a first 2H time period when the common voltage VCOM of the first level is applied to the common electrode, first image signals 111a corresponding to the (4K−3)-th and (4K−1)-th scan lines are read in sequence, and during a next 2H time period when the common voltage VCOM of the second level is applied to the common electrode, the first image signals 111a corresponding to the (4K−2)-th and 4K-th scan lines are read.

The memory 113 stores, for example the first image signals 111a by a unit of frames or by a unit of lines. The memory 113 has, for example a storage capacity for data corresponding to at least two lines.

The first image signals 111a that are read from the memory 113 are transformed into the second image signals by the control section 112, and the second image signals are applied to the data driving section 140.

The data driving section 140 transforms the second image signals provided from the control section 112 into data signals D1, D2, . . . , Dm that correspond to analog signals, and the data driving section 140 applies the data signals D1, D2, . . . , Dm to the data lines DL1, DL2, . . . DLm. Output terminals of the data driving section 140 are electrically connected to the data lines DL1, DL2, . . . DLm. The data signals D1, D2, . . . , Dm are outputted to be inverted by the inversion signal RVS that corresponds to one of the second control signals.

The level shifter 115 shifts the third control signal 112b to output a scan start signal STV, a first clock signal CK, a second clock signal CKB, a first source voltage VOFF and a second source voltage VON.

The common voltage generating section 116 generates the common voltage VCOM applied to the common electrode of the liquid crystal capacitor of the display section 130. The common voltage VCOM has a time period of 4H.

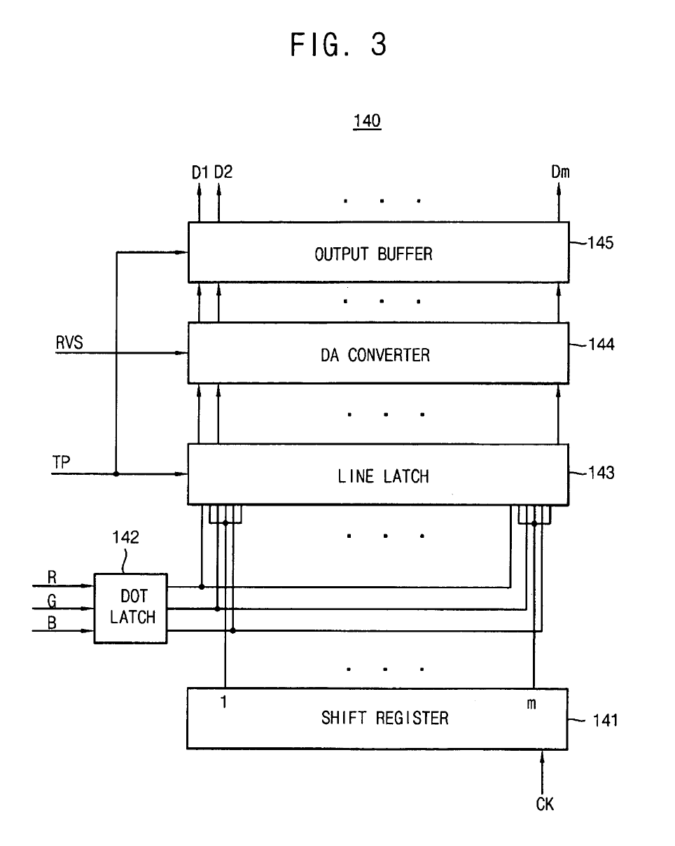

FIG. 3 is a block diagram illustrating a data driving section in FIG. 2.

Referring to FIG. 3, the data driving section 140 includes a shift register 141, a dot latch 142, a line latch 143, a digital to analog (DA) converter 144 and an output buffer 145. The shift register 141 applies a latch pulse to the line latch 143 responsive to the second control signal 112a provided by the control section 110. The dot latch 142 latches the second image signals (or red, green and blue (RGB) data) provided in sequence from the control section 110 responsive to the second control signal 112a, and the dot latch 142 applies the RGB data to the line latch 143 when the latch pulse is outputted from the shift register 141. The line latch 143 latches RGB data by a unit of 1-line. When the load signal TP of the second control signal 112a is inputted, the line latch 143 outputs the RGB data latched by the unit of 1-line. The DA converter 144 inverts the RGB data outputted by the unit of 1-line, responsive to the inversion signal RVS, and converts the inverted RGB data into the data signals D1, D2, . . . , Dm of an analog type. The output buffer 145 amplifies the data signals D1, D2, . . . , Dm and applies the amplified data signals D1, D2, . . . , Dm to the data lines DL1, DL2, . . . , DLm of the display section 130.

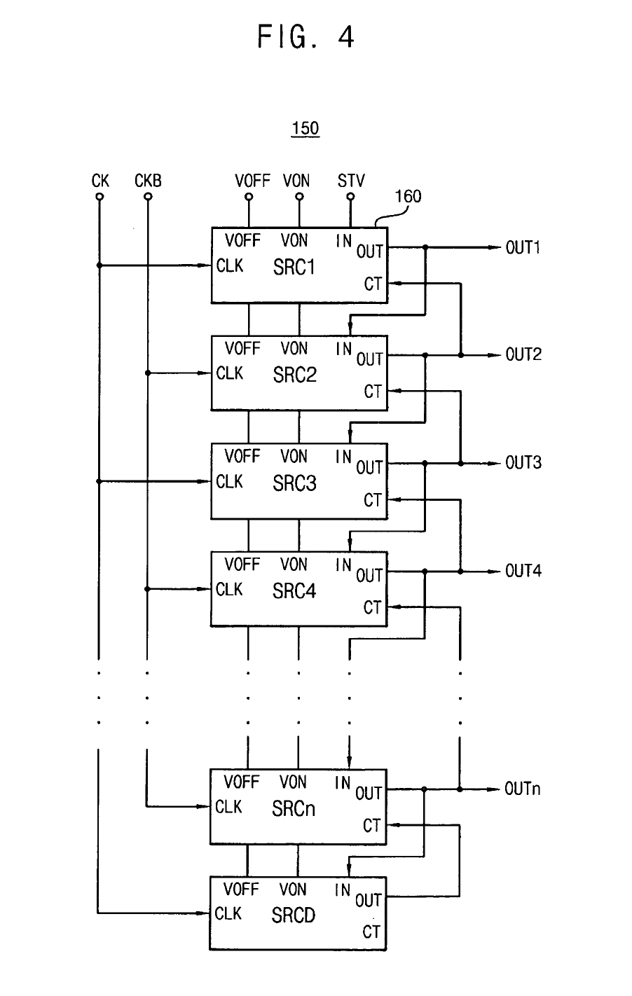

FIG. 4 is a block diagram illustrating a scan driving section in FIG. 1.

Referring to FIG. 4, the scan driving section 150 includes a shift register having stages SRC1, SRC2, . . . , SRCn and a dummy stage SRCD. The stages SRC1, SRC2, . . . , SRCn are electrically connected to each other. For example, an output terminal of one of the stages SRC1, SRC2, . . . , SRCn is electrically connected to an input terminal of a next one of the stages SRC2, SRC3, . . . , SRCn.

The stages SRC1, SRC2, . . . , SRCn correspond to the scan lines SL1, SL2, SLn, respectively. Each of the stages SRC1, SRC2, . . . , SRCn includes an input terminal IN, an output terminal OUT, a control terminal CT, a clock signal input terminal CLK, a first source voltage terminal VOFF and a second source voltage terminal VON.

The scan start signal STV is applied to the input terminal IN of a first stage SRC1, and an output signal of one of the stages SRC1, SRC2, . . . , SRCn is applied to the input terminal IN of the next one of the stages SRC2, SRC3, . . . , SRCn. Each of the stages SRC1, SRC2, . . . , SRCn may further include a carry signal generating part, so that a carry signal outputted from the carry signal generating part may be applied to the input terminal of the next one of the stages SRC2, SRC3, . . . , SRCn.

The output terminals OUT1, OUT2, . . . , OUTn of the stages SRC2, SRC3, SRCn are electrically connected to the scan lines SL1, SL2, . . . , SLn, respectively. The first clock signal CK is applied to the clock signal input terminal CLK of odd-numbered stages SRC1, SRC3, . . . , and second clock signal CKB is applied to the clock signal input terminal CLK of even-numbered stages SRC2, SRC4, . . . . The first and second clock signals CK and CKB have opposite phases.

The output terminals OUT2, . . . , OUTn and OUT of the stages SRC2, SRC3 SRCn and dummy stages are electrically connected to the control terminals CT of previous stages SRC1, SRC2, . . . , SRCn-1, respectively. The output signal outputted from the stages SRC2, SRC3, . . . , SRCn resets the previous stages SRC1, SRC2, . . . , SRCn-1, so that the output signal of the previous stages SRC1, SRC2, . . . , SRCn-1 is pulled down. Therefore, each stage SRC1, SRC2, . . . , SRCn outputs a high-leveled signal in sequence, so that the scan lines SL1, SL2, . . . , SLn corresponding to the each stage SRC1, SRC2, . . . , SRCn are activated in sequence.

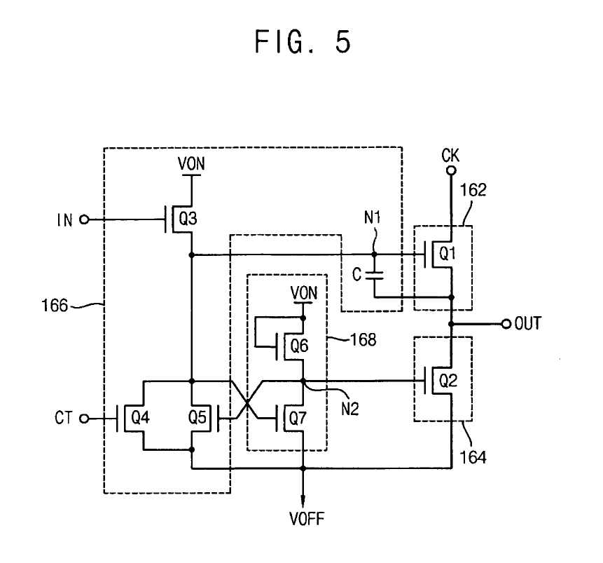

FIG. 5 is a block diagram illustrating a unit stage of the shift register shown in FIG. 4.

Referring to FIG. 5, a stage 160 from among the stages SRC1, SRC2, . . . , SRCn shown in FIG. 4 includes a pull up part 162, a pull down part 164, a pull up driving part 166 and a pull down driving part 168. The pull up part 162 includes a first transistor Q1. The first transistor Q1 includes a drain electrode that is electrically connected to the clock signal input terminal CLK, a gate electrode that is electrically connected to a first node N1, and a source electrode that is electrically connected to the output terminal OUT. The pull down part 164 includes a second transistor Q2. The second transistor Q2 includes a drain electrode that is electrically connected to the output terminal OUT, a gate electrode that is electrically connected to a second node N2, and a source electrode that is electrically connected to the first source voltage VOFF. The pull up driving part 166 includes a capacitor ‘C’, a third transistor Q3, a fourth transistor Q4 and a fifth transistor Q5. The capacitor ‘C’ includes a first electrode that is electrically connected to the first node N1, and a second electrode that is electrically connected to the output terminal OUT. The third transistor Q3 includes a drain electrode that is electrically connected to the second source voltage VON, a gate electrode that is electrically connected to the input terminal IN, and a source electrode that is electrically connected to the first node N1. The second transistor Q2 includes a drain electrode that is electrically connected to the first node N1, a gate electrode that is electrically connected to the control terminal CT, and a source electrode that is electrically connected to the first source voltage VOFF. The fifth transistor Q5 includes a drain electrode that is electrically connected to the first node N1, a gate electrode that is electrically connected to the second node N2, and a source electrode that is electrically connected to the first source voltage VOFF. A size of the third transistor Q3 is about two times larger than a size of the fifth transistor Q5.

The pull down driving section 168 includes a sixth transistor Q6 and a seventh transistor Q7. The sixth transistor Q6 includes a drain electrode, a gate electrode and a source electrode. The drain and gate electrodes of the sixth transistor Q6 are electrically connected to the second source voltage VON. The source electrode of the sixth transistor Q6 is electrically connected to the second node N2. The seventh transistor Q7 includes a drain electrode that is electrically connected to the second node N2, a gate electrode that is electrically connected to the first node N1, and a source electrode that is electrically connected to the first source voltage VOFF. A size of the sixth transistor Q6 is about sixteen times larger than a size of the seventh transistor Q7.

The first through seventh transistors Q1 through Q7 may be formed to have identical characteristics as transistors disposed in the display section 130, which are electrically connected to pixel electrodes including indium tin oxide (ITO). For example, the first through seventh transistors Q1 through Q7 correspond to an amorphous silicon TFT including an amorphous-silicon (a—Si) layer and an N+ doped a—Si layer formed on the a—Si layer.

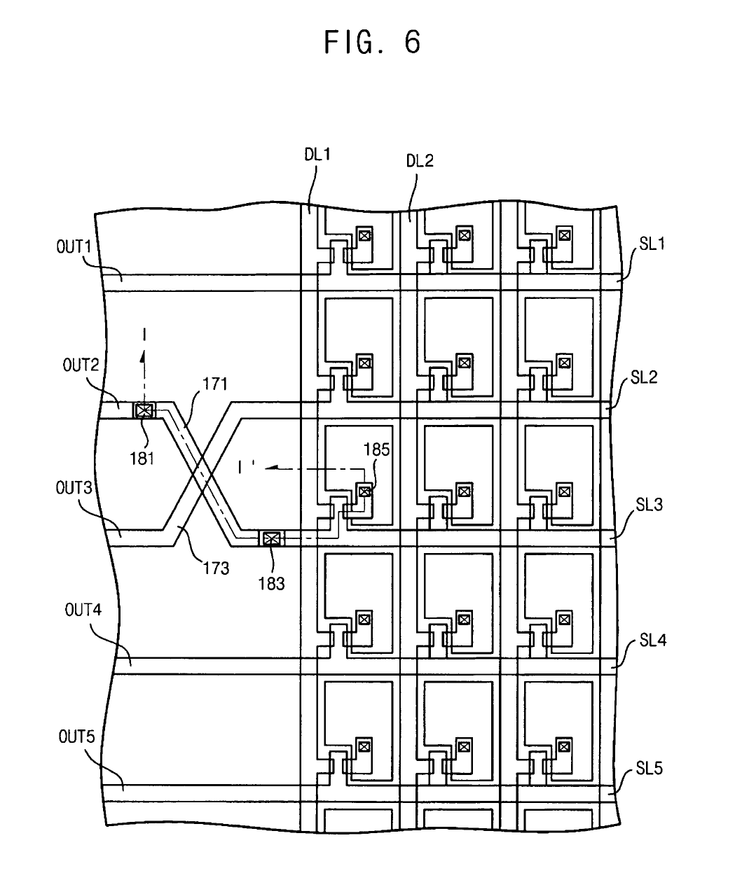

FIG. 6 is a layout illustrating an electrical connection between output terminals of the scan driving section and scan lines in a display section in FIG. 1.

Referring to FIG. 6, the scan driving section 150 includes the stages SRC1, SRC2, . . . , SRCn electrically connected to each other. Output terminals of the stages OUT1, OUT2, . . . , OUTn are electrically connected to input terminals IN of the next stages as shown in FIG. 4. Additionally, each of the output terminals of the stages OUT1, OUT2, . . . , OUTn is electrically connected to one of the scan lines SL1, SL2, . . . , SLn.

For example, the output terminal OUT1 of the (4K−3)-th stage is electrically 10 connected to the (4K−3)-th scan line SL1. The output terminal OUT2 of the (4K−2)-th stage is electrically connected to the (4K−1)-th scan line SL3. The output terminal OUT3 of the (4K−1)-th stage is electrically connected to the (4K−2)-th scan line SL2. The output terminal OUT4 of the 4K-th stage is electrically connected to the 4K-th scan line SL4. In other words, the output terminal of the (4K−2)-th stage and the output terminal of the (4K−1)-th stage are electrically connected to the (4K−1)-th scan line and the (4K−2)-th scan line, respectively.

A first connection line 171 connecting the output terminal OUT2 of the (4K−2)-th stage to the (4K−1)-th scan line, and a second connection line 173 connecting the output terminal OUT3 of the (4K−1)-th stage to the (4K−2)-th scan line are disposed on different layers.

For example, the second connection line 173 is formed through a first metal layer that is electrically connected to the output terminal OUT3 of the (4K−1)-th stage and the (4k−2)-th scan line SL2. The first connection line 171 is formed through a second metal layer that is electrically connected to the output terminal OUT2 of the (4K−2)-th stage and the (4K−1)-th scan line SL3 through a first contact hole 181 and a second contact hole 183, respectively.

Therefore, an electrical short between the first and second connection lines 171 and 173 is prevented. As long as the output terminal of the (4K−2)-th stage and the output terminal of the (4K−1)-th stage are electrically connected to the (4K−1)-th scan line and the (4K−2)-th scan line, respectively, the first and second connection lines 171 and 173 may have arbitrary structures.

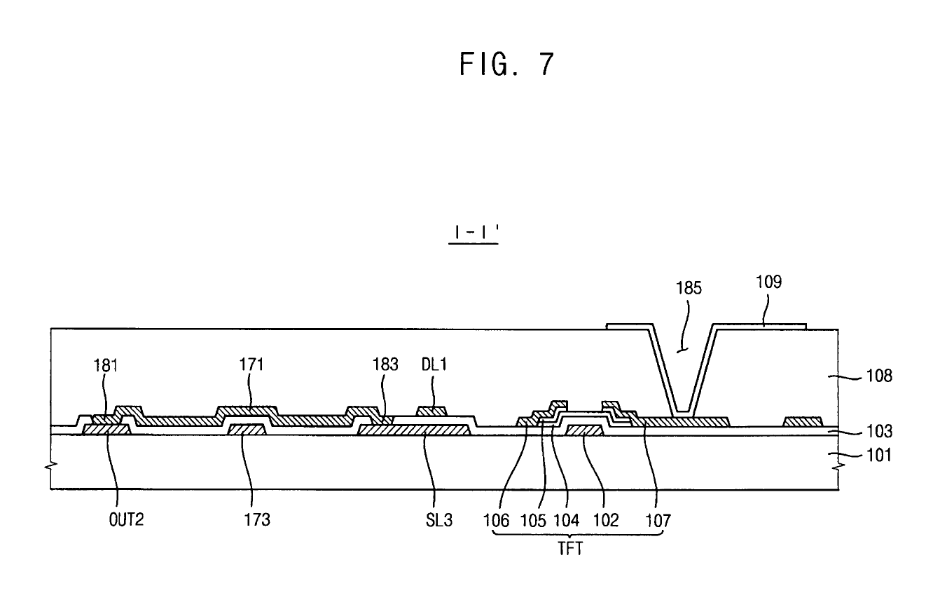

FIG. 7 is a cross-sectional view taken along line I-I′ in FIG. 6.

Referring to FIG. 7, the scan line SL3, the data line DL1, the TFT and other wiring are formed on a transparent substrate 101. Hereinafter, a process of manufacturing the first and second connection lines 171 and 173 through a process of forming the TFT will be explained.

The first metal layer 102 for a gate electrode of the TFT is disposed on the transparent electrode 101. The first metal layer 102 is patterned to form the scan line SL3, the second connection line 173 and the output terminal OUT2 of the stage. The output terminal OUT2 corresponds to the output terminal OUT2 of the (4K−2)-th stage in FIG. 6, and the second connection line 173 connects the output terminal OUT3 with the (4K−2)-th scan line SL2.

A gate insulating layer 103 is disposed on the transparent substrate 101. An activation layer 104 is disposed on the gate insulating layer 103 and an ohmic contact layer 105 is disposed on the activation layer 104. An amorphous silicon (a—Si) layer may be employed as the activation layer 104, and N+ doped a—Si layer may be employed as the ohmic contact layer 105. The gate insulating layer 103 is patterned to form the first contact hole 181 for connecting the output terminal OUT2 of the (4K−2)-th stage to the first connection line 171, and the second contact hole 183 for connecting the scan line SL3 to the first connection line 171. The first connection line 171 connects the output terminal OUT2 of the (4K−2)-th stage to the (4K−1)-th scan line SL3.

The second metal layer for forming a source electrode 106 and a drain electrode 107 is disposed on the transparent substrate 101 having the ohmic contact layer 105 disposed thereon such that the second metal layer covers the ohmic contact layer 105 and a portion of the gate insulating layer 103. The second metal layer is patterned to form the first connection line 171 and the data line DL1. The first connection line 171 electrically connects the output terminal OUT2 of the (4K−2)-th stage with the (4K−1)-th scan line SL3 through the first and second contact holes 181 and 183.

An organic insulation layer 108 is disposed on the transparent substrate 101 having the source and drain electrodes 106 and 107, the data line DL1, and the first connection line 171 disposed thereon. The organic insulating layer 108 is patterned to form a third contact hole 185. The third contact hole 185 exposes a portion of the drain electrode 107, so that a pixel electrode 109 is electrically connected to the drain electrode 107 through the third contact hole 185.

Therefore, the first and second connection lines 171 and 173 may be formed such that the first and second connection lines 171 and 173 are disposed at different layers.

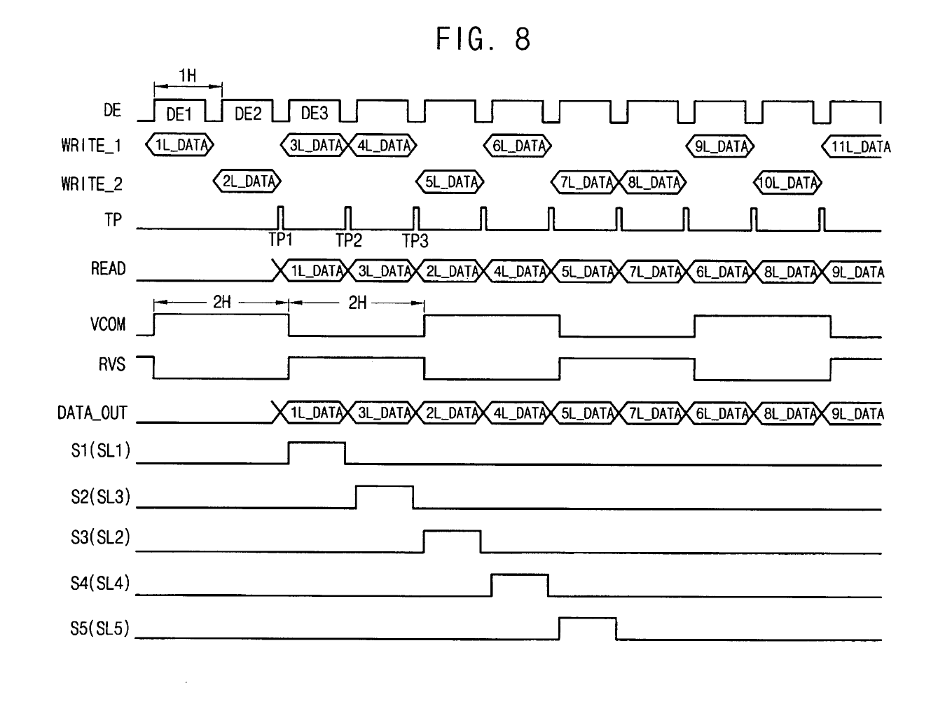

FIG. 8 is a timing diagram illustrating input signals and output signals of the LCD device in FIG. 1.

Referring to FIG. 8, the control section 112 writes the first image signal 111a at the memory 113, responsive to the data enable signal DE that corresponds to the first control signal 111b provided from an external device. Hereafter, ‘WRITE_1’ represents a timing diagram for writing data at a first address of the memory 113, and ‘WRITE_2’ represents a timing diagram for writing data at a second address of the memory 113.

The control section 112 stores the first image signal 111a in the memory 113 by a line synchronized with the data enable signal DE. For example, a first line data 1L_DATA is stored in the first address, and a second line data 2L_DATA is stored in the second address.

When the second line data 2L_DATA is stored in the second address, the control section 112 generates the load signal TP, responsive to the data enable signal DE. When a first load signal TP1 is generated, the control section 112 reads the first line data 1L_DATA from the first address, and then a third line data 3L_DATA is stored in the first address. When a second load signal TP2 is generated, the control section 112 reads the third line data 3L_DATA from the first address and stores a fourth line data 4L_DATA to the first address. When a third load signal is generated, the control section 112 reads the second line data 2L_DATA from the second address and stores a fifth line data 5L_DATA to the second address. The above-described process continues in sequence for sixth to eleventh line data 6L_DATA to 11L_DATA. Thus, in order to perform 1-line inversion by using the common voltage having a time period of 4H, data of adjacent two lines having a same level are read in sequence.

As shown in FIG. 8, during a first 2H time when the common voltage is at the first level, data corresponding to (4K−3)-th line and data corresponding to (4K−1)-th line, which have the second level, are read in sequence, and then during a next 2H time when the common voltage is at the second level, data corresponding to (4K−2)-th line and data corresponding to 4K-th line, which have the first level, are read in sequence. When a data is read from one address of the memory 113, a next data is stored in the address.

The first line data 1L_DATA, the third line data 3L_DATA, the second line data 2L_DATA and the fourth line data 4L_DATA are read in sequence. The above line data are transformed into an analog signal, and the analog signal is applied to the data lines DL1, DL2, . . . , DLm.

A scan signal is applied to scan lines SL1, SL2, . . . , SLn in accordance with a sequence of the line data.

The (4K−3)-th scan signal S1 is applied to the (4K−3)-th scan line SL1, the (4K−2)-th scan signal S2 is applied to the (4K−1)-th scan line SL3, the (4K−1)-th scan signal S3 is applied to the (4K−2)-th scan line SL2, 4K-th scan signal S4 is applied to the 4K-th scan line SL4, and a (4k+1)-th scan signal S5 is applied to a (4k+1)-th scan line SL5.

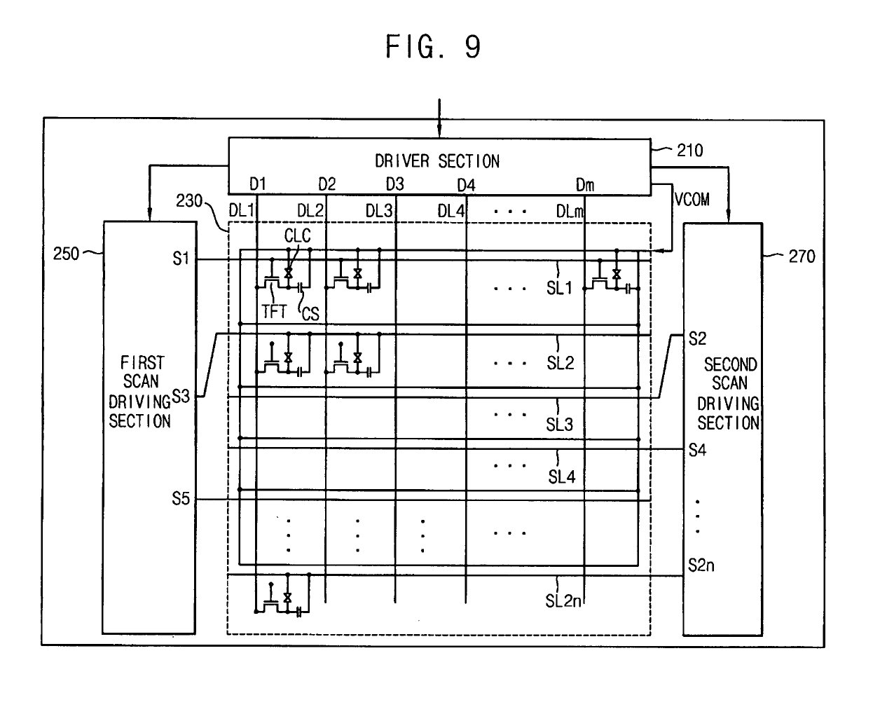

FIG. 9 is a schematic block diagram illustrating an LCD device according to an exemplary embodiment of the present invention.

Referring to FIG. 9, an LCD device includes a driver section 210, a display section 230, a first scan driving section 250 and a second scan driving section 270.

The driver section 210 applies a data signal and a common voltage VCOM to the display section 230, and the driver section 210 applies control signals to the first and second scan driving sections 250 and 270, respectively. The driver section 210 applies data signals D1, D2, . . . , Dm responsive to a second level to the data lines DL1, DL2, . . . , DLm for a first time period 2H, and the driver section 210 applies data signals D1, D2, . . . , Dm responsive to a first level to the data lines DL1, DL2, . . . , DLm for a next time period 2H.

The driver section 210 controls the first and second scan driving sections 250 and 270 such that a (4K−3)-th scan line and a (4K−1)-th scan line are activated in sequence for a first time period 2H, and a (4K−2)-th scan line and a 4K-th scan line are activated in sequence for a next time period 2H.

The display section 230 includes the data lines DL1, DL2, . . . , DLm, and scan lines SL1, SL2, . . . , SLn. Each of the data lines DL1, DL2, . . . , DLm is substantially perpendicular to each of the scan lines SL1, SL2, . . . , SLn. One of the data lines DL1, DL2, . . . , DLm and one of the scan lines SL1, SL2, . . . , SLn define a pixel, so that m×n (m times n) number of pixels are defined on the display section 230. Each pixel includes a switching device such as a TFT, a liquid crystal capacitor CLC and a storage capacitor CS.

The TFT includes a gate electrode that is electrically connected to one of the scan lines SL1, SL2, . . . , SLn, a source electrode that is electrically connected to one of the data lines DL1, DL2, . . . , DLm, and a drain electrode that is electrically connected to a pixel electrode that corresponds to a first electrode of the liquid crystal capacitor CLC.

A common voltage outputted from the driver section 210 is applied to a common electrode that corresponds to a second electrode of the liquid crystal capacitor CLC. The common voltage VCOM has a time period of 4H.

The first scan driving section 250 applies odd numbered scan signals S1, S3, . . . , S2n-1 to the scan lines of the display section 230 in sequence responsive to the control signal provided from the driver section 210. For example, the first scan driving section 250 applies a (4K−3)-th scan signal (for example, S1) to a (4K−3)-th scan line (for example, SL1), and the first scan driving section 250 applies a (4K−1)-th scan signal (for example, S3) to a (4K−2)-th scan line (for example, SL2), wherein ‘K’ represents a natural number.

The second scan driving section 270 applies even numbered scan signals S2, S4, . . . , S2n to the scan lines SL1, SL2, . . . , SLn of the display section 230 in sequence responsive to the control signal provided from the driver section 210. For example, the second scan driving section 270 applies a (4K−2)-th scan signal (for example, S2) to a (4K−1)-th scan line (for example, SL3), and the second scan driving section 270 applies a 4K-th scan signal (for example, S4) to a 4K-th scan line (for example, SL4).

The first and second scan driving sections 250 and 270 may be formed through a process of manufacturing a—Si TFTs in the display section 230, so that TFTs of the first and second scan driving sections 250 and 270 correspond to an a—Si TFT.

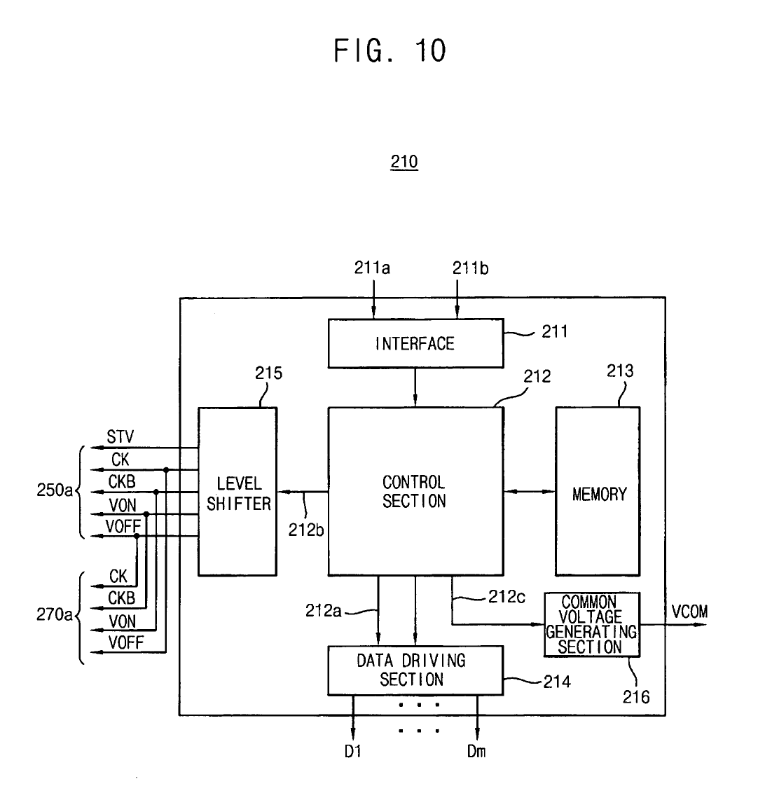

FIG. 10 is a block diagram illustrating a driver section in FIG. 9.

Referring to FIG. 10, the driver section 210 includes an interface 211, a control section 212, a memory 213, a data driving section 214, a level shifter 215 and a common voltage generating section 216. The interface 211 interfaces a first image signal 211a and a first control signal 211b to the control section 212.

The control section 212 transforms the first image signal 211a into a second image signal that is compatible with the data driving section 214, and the control section 212 also outputs a second control signal 212a, a third control signal 212b and a fourth control signal 212c responsive to the first control signal 211b. The first control signal 211b includes a horizontal synchronization signal HSYNC, a vertical synchronization signal VSYNC, a main clock signal MCK and a data enable signal DE. The second control signal 212a corresponds to a signal for controlling the data driving section 214. The second control signal 212a includes a horizontal start signal STH, a load signal TP and an inversion signal RVS. The third control signal 212b corresponds to a signal for controlling the level shifter 215. The fourth control signal 212c corresponds to a signal for controlling the common voltage generating section 216. The common voltage generating section is controlled such that a period of the common voltage VCOM is 4H.

The control section 212 also controls the memory 213 to write the first image signal 211a, and controls the memory 213 to read the first image signal 211a that is stored by the memory 213. The control section 212 reads the first image signal 211a having an inverted reference level with respect to the common voltage VCOM as the first image signal 211a stored in the memory 213.

During a first 2H time period when the common voltage VCOM of the first level is applied to the common electrode, first image signals 211a corresponding to the (4K−3)-th and (4K−1)-th scan lines are read in sequence, and during a next 2H time period when the common voltage VCOM of the second level is applied to the common electrode, the first image signals 211a corresponding to the (4K−2)-th and 4K-th scan lines are read.

The memory 213 stores, for example, the first image signals 211a by a unit of frames or by a unit of lines. The memory 213 has, for example, a storage capacity for data corresponding to at least two lines.

The first image signals 211a that are read from the memory 213 are transformed into the second image signals by the control section 212, and the second image signals are applied to the data driving section 214.

The data driving section 214 transforms the second image signals provided from the control section 212 into data signals D1, D2, . . . , Dm that correspond to analog signals, and the data driving section 214 applies the data signals D1, D2, . . . , Dm to the data lines DL1, DL2, . . . DLm. Output terminals of the data driving section 214 are electrically connected to the data lines DL1, DL2, . . . DLm. The data signals D1, D2, . . . , Dm are outputted to be inverted by the inversion signal RVS that corresponds to one of the second control signals.

The level shifter 215 shifts the third control signal 212b to output a scan start signal STV, a first clock signal CK, a second clock signal CKB, a first source voltage VOFF and a second source voltage VON. A first scan control signal 250a includes the scan start signal STV, the first clock signal CK, the second clock signal CKB, the first source voltage VOFF and the second source voltage VON, and a second scan control signal 270a includes the first clock signal CK, the second clock signal CKB, the first source voltage VOFF and the second source voltage VON.

The common voltage generating section 216 generates the common voltage VCOM applied to the common electrode of the liquid crystal capacitor CLC of the display section 230. The common voltage VCOM has a time period of 4H.

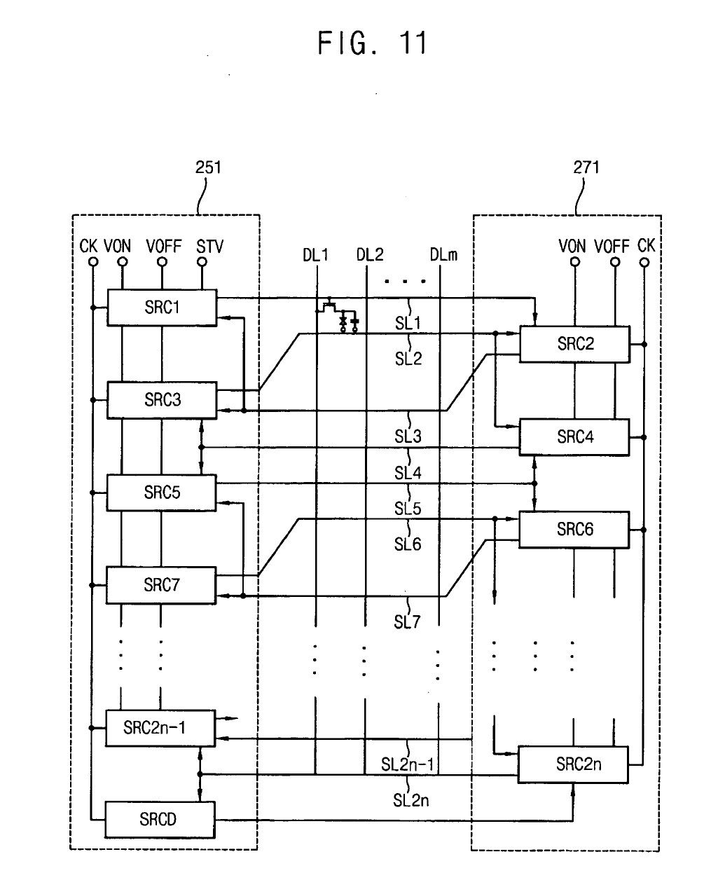

FIG. 11 is a block diagram illustrating a first scan driving section and a second driving section in FIG. 9.

Referring to FIG. 11, the first scan driving section 250 includes a first shift register 251 having stages SRC1, SRC3, . . . , SRC2n-1, SRCD. The second scan driving section 270 includes a second shift register 271 having stages SRC2, SRC4, . . . , SRC2n. The first scan driving section 250 is disposed at a first end portion of scan lines SL1, SL2, . . . , SL2n, and the second scan driving section 270 is disposed at a second end portion of the scan lines SL1, SL2, . . . , SL2n. The first and second shift registers 251 and 271 may be formed through a process of manufacturing a—Si TFTs in the display section 230. The last stage SRCD of the first shift register 251 corresponds to a dummy stage for applying a control signal to stage SRC2n of the second shift register 271.

An output signal of the (4K−3)-th stage SRC1 of the first shift register 251 is applied to the (4K−2)-th stage SRC2 of the second shift register 271 through the (4K−3)-th scan line SL1.

An output signal of the (4K−2)-th stage SRC2 of the second shift register 271 is applied to the (4K−1)-th stage SRC3 of the first shift register 251 through the (4K−1)-th scan line SL3 as an input signal, and the output signal of the (4K−2)-th stage SRC2 of the second shift register 271 is applied to the (4K−3)-th stage SRC1 of the first shift register 251 as a control signal.

An output signal of the (4K−1)-th stage SRC3 of the first shift register 251 is applied to the 4K-th stage SRC4 of the second shift register 271 through the (4K−2)-th scan line SL2 as an input signal, and the output signal of the (4K−1)-th stage SRC3 of the first shift register 251 is applied to the (4K−2)-th stage SRC2 of the second shift register 271 as a control signal.

An output signal of the 4K-th stage SRC4 of the second shift register 271 is applied to the (4K+1)-th stage SRC5 of the first shift register 251 through the 4K-th scan line SL4 as an input signal, and the output signal of the 4K-th stage SRC4 of the second shift register 271 is applied to the (4K−1)-th stage SRC3 of the second shift register 271 as a control signal.

The first and second shift registers 251 and 271 of the first and second scan driving sections 250 and 270, respectively, operate as described above to generate scan signals S1, S2, . . . , S2n, and activate scan lines 4K−3, 4K−1, 4K−2 and 4K in sequence by a connection between the output terminals of the stages and the scan lines.

A method of driving the LCD device according to the present embodiment is substantially the same as that of previous embodiments. Therefore, any further explanation will be omitted.

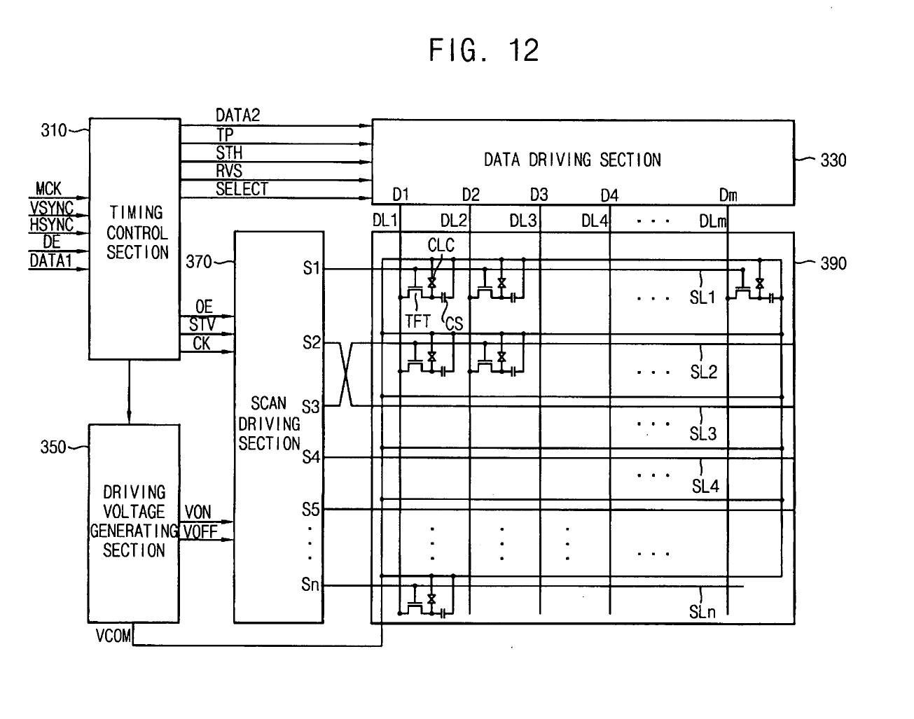

FIG. 12 is a schematic block diagram illustrating an LCD device according to another exemplary embodiment of the present invention.

Referring to FIG. 12, an LCD device according to the present embodiment includes a timing control section 310, a data driving section 330, a driving voltage generating section 350, a scan driving section 370 and an LCD panel 390.

The timing control section 310 transforms a first image signal DATA1 provided from an external device (not shown) into a second image signal DATA2 for the data driving section 330. The timing control section 310 generates second, third and fourth control signals, responsive to a first control signal.

The first control signal includes a main clock signal MCK, a horizontal synchronization signal HSYNC, a vertical synchronization signal VSYNC and a data enable signal DE. The second control signal includes a vertical start signal STH, an inversion signal RVS, a load signal TP and a selection signal SELECT. The third control signal controls the driving voltage generating section 350. The third control signal controls a common voltage VCOM to have a 4H time period. The fourth control signal includes a scan start signal STV, a clock signal CK and an output enable signal OE for driving the scan driving section 370.

The data driving section 330 transforms the second image signal DATA2 into data signals D1, D2, . . . , Dm, responsive to the second control signal to apply the 10 data signals D1, D2, . . . , Dm to data lines DL1, DL2, . . . , DLm. The data driving section 330 has a storing capacity for storing the second image signal DATA2 of two vertical lines. The data driving section 330 selects the second image signal DATA2 corresponding to specific lines responsive to the selection signal SELECT. For example, the data driving section 330 selects the second image signal DATA2 having an inverse level with respect to the common voltage VCOM. The data driving section 330 outputs a data signal corresponding to the (4K−3)-th line and the (4K−1)-th line having the second level in sequence during a first 2H time period when the common voltage VCOM of the first level is outputted, and then outputs a data signal corresponding to the (4K−2)-th line and the 4K-th line having the first level in sequence during a next 2H time period when the common voltage VCOM of the second level is outputted.

The driving voltage generating section 350 generates the first and second source voltages VOFF and VON, and the common voltage VCOM. The common voltage VCOM has a 4H time period.

The scan driving section 370 applies scan signals S1, S2, . . . , Sn to scan lines SL1, SL2, . . . , SLn of the LCD panel 390, respectively. According to a 1-line inversion by the common voltage VCOM having the 4H time period, scan signals for activating the (4K−3)-th and (4K−1)-th scan lines in sequence are outputted during a first 2H time period, and then scan signals for activating the (4K−2)-th and 4K-th scan lines in sequence are outputted during a next 2H time period.

The LCD panel 390 includes a TFT substrate, a color filter substrate and a liquid crystal layer disposed between the TFT substrate and the color filter substrate. The TFT substrate includes the data lines DL1, DL2, . . . , DLm, and the scan lines SL1, SL2, . . . , SLn. Each of the data lines DL1, DL2, . . . , DLm is extended in a first direction, and each of the scan lines SL1, SL2, . . . , SLn is extended in a second direction that is substantially perpendicular to the first direction.

One of the data lines DL1, DL2, . . . , DLm and one of the scan lines SL1, SL2, SLn define a pixel, so that m×n (m times n) number of pixels are defined on the display section. Each pixel includes a switching device such as a TFT, a liquid crystal capacitor CLC and a storage capacitor CS.

The TFT includes a gate electrode that is electrically connected to one of the scan lines SL1, SL2, . . . , SLn, a source electrode that is electrically connected to one of the data lines DL1, DL2, . . . , DLm, and a drain electrode that is electrically connected to a pixel electrode that corresponds to a first electrode of the liquid crystal capacitor CLC. The storage capacitor CS is defined by the gate electrode and the pixel electrode.

The color filter substrate includes color filters corresponding to the pixel electrode of the TFT substrate, and a common electrode that corresponds to a second electrode of the liquid crystal capacitor CLC.

The common voltage having the 4H time period is applied to the second electrode of the liquid crystal capacitor CLC and the common electrode of the storage capacitor CS.

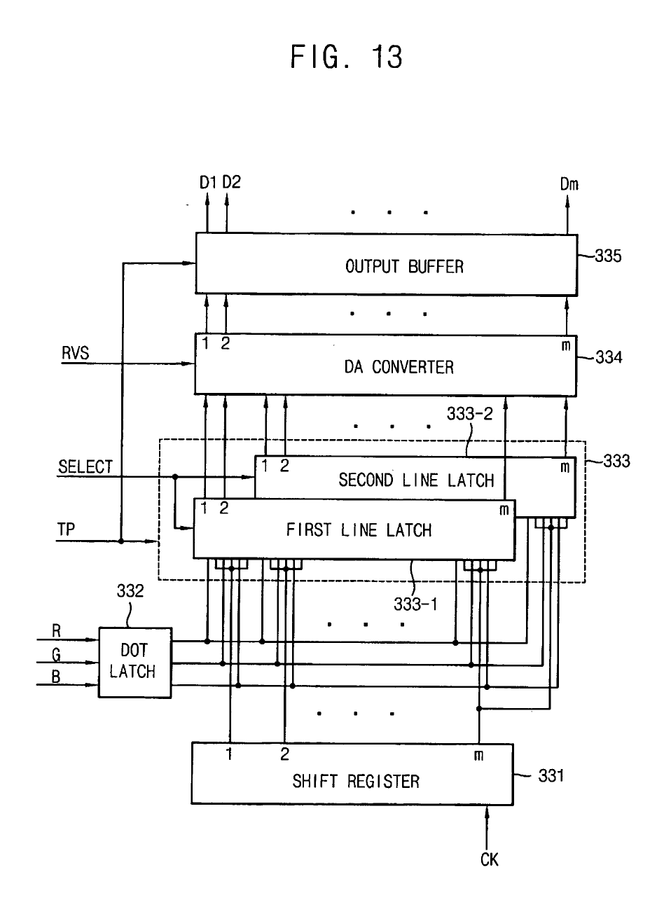

FIG. 13 is a block diagram illustrating a data driving section in FIG. 12.

Referring to FIG. 13, the data driving section 330 includes a shift register 331, a dot latch 332, a line latch portion 333, a digital to analog (DA) converter 334 and an output buffer 335.

The shift register 331 applies a latch pulse to the line latch portion 333, responsive to a control signal provided from the timing control section 310. The shift register 331 is receptive of the clock signal CK.

The dot latch 332 latches a second data signal (or RGB data) provided from the timing control section 310 and applies the second data signal to the line latch portion 333, responsive to a latch signal provided from the shift register 331.

The line latch portion 333 includes a first line latch 333-1 and a second line latch 333-2. The first and second line latches 333-1 and 333-2 latch data provided from the dot latch 332. The line latch portion 333 outputs one line data latched by the first and second line latches 333-1 and 333-2, and a next line data is latched.

Data of (4K−3)-th line and (4K−1)-th line, which have the second level, are selected in sequence by the selection signal SELECT during the first 2H time period when the common voltage VCOM having the first level is outputted, and then data of (4K−2)-th line and 4K-th line, which have the first level, are selected in sequence by the selection signal SELECT during the next 2H time period when the common voltage VCOM having the second level is outputted.

The DA converter 334 inverts the RGB data outputted by the unit of 1-line, responsive to the inversion signal RVS, and converts inverted RGB data into the data signals D1, D2, . . . , Dm corresponding to analog signals.

The output buffer 335 amplifies the data signals D1, D2, . . . , Dm corresponding to analog signals and applies the data signals D1, D2, . . . , Dm that have been amplified to the data lines DL1, DL2, . . . , DLm, respectively. The shift register 331, the first and second line latches 333-1 and 333-2, and the DA converter 334 each have output terminals 1, 2, . . . , m that correspond to the data lines DL1, DL2, . . . , DLm, respectively. Additionally, the line latch 333, the DA converter 334 and the output buffer are receptive of the load signal TP.

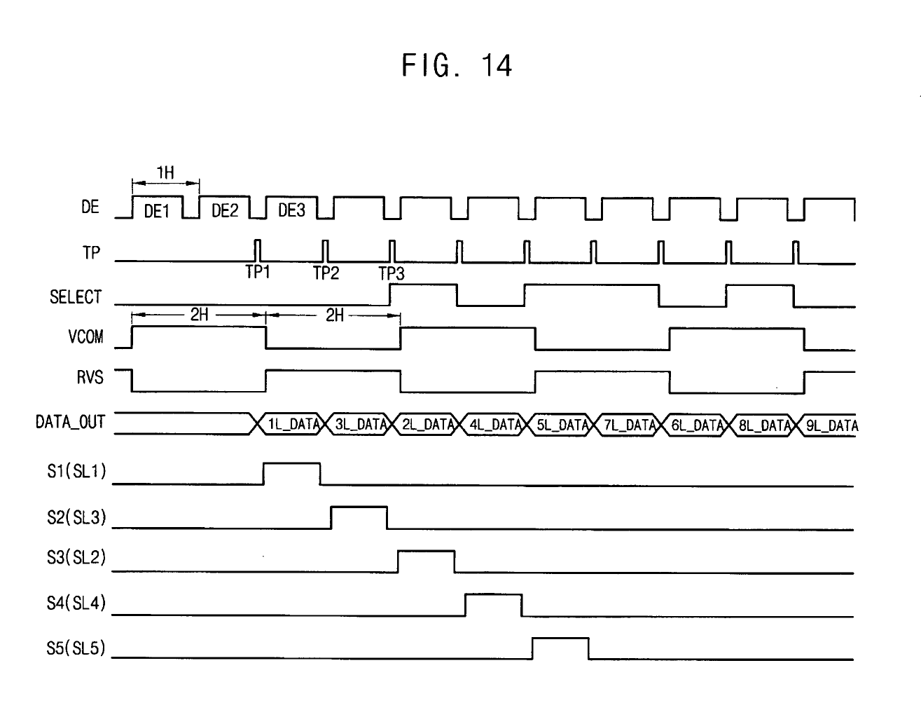

FIG. 14 is a timing diagram illustrating input signals and output signals of the LCD device in FIG. 12.

Referring to FIGS. 12-14, the timing control section 310 applies the second image signal DATA2 and the second control signal to the data driving section 330, responsive to the first image signal DATA1 and the first control signal provided from an external device.

The line latch portion 333 latches data having a dot unit and applies the data to the data driving section 330 as a line data through the shift register 331 and the dot latch 332. The line latch portion 333 latches two line data through the first and second line latches 333-1 and 333-2.

The timing control section 310 outputs the two line data latched by the line latch portion 333, responsive to the load signal TP and the selection signal SELECT. For example, when the selection signal SELECT is in a low level, the line data latched by the first line latch 333-1 is outputted, and when the selection signal SELECT is in a high state, the line data latched by the second line latch 333-2 is outputted.

The line latch portion 333 outputs data corresponding to the (4K−3)-th line and the (4K−1)-th line having a second level (or high level) in sequence, during a first 2H time period when the common voltage VCOM has a first level (or low level), and then the line latch portion 333 outputs data corresponding to the (4K−2)-th line and the 4K-th line having the first level (or low level) in sequence, during a next 2H time period when the common voltage VCOM has the second level (or high level).

When one of the line data latched by the first and second line latches 333-1 and 333-2 is outputted, a line data corresponding to a next line is latched by vacant latches between the first and second line latches 333-1 and 333-2. As described above, the line data outputted from the line latch portion 333 is inverted with respect to the common voltage VCOM and transformed into an analog signal.

Data outputted DATA_OUT from the output buffer 335 corresponds to the first line data 1L-DATA, the third line data 3L-DATA, the second line data 2L-DATA, and the fourth line data 4L-DATA in sequence responsive to the first, second and third, etc load signals TP1, TP2, TP3, etc. The scan signal is applied to the scan lines in accordance with an order of the outputted line data. The above-described process continues in sequence for fifth to ninth line data 5L_DATA to 9L_DATA.

The (4K−3)-th scan signal S1 is applied to the (4K−3)-th scan line SL1, the (4K−2)-th scan signal S2 is applied to the (4K−1)-th scan line SL3, the (4K−1)-th scan signal S3 is applied to the (4K−2)-th scan line SL2, the 4K-th scan signal S4 is applied to the 4K-th scan line SL4, and a (4k+1)-th scan signal S5 is applied to a (4k+1)-th scan line SL5.

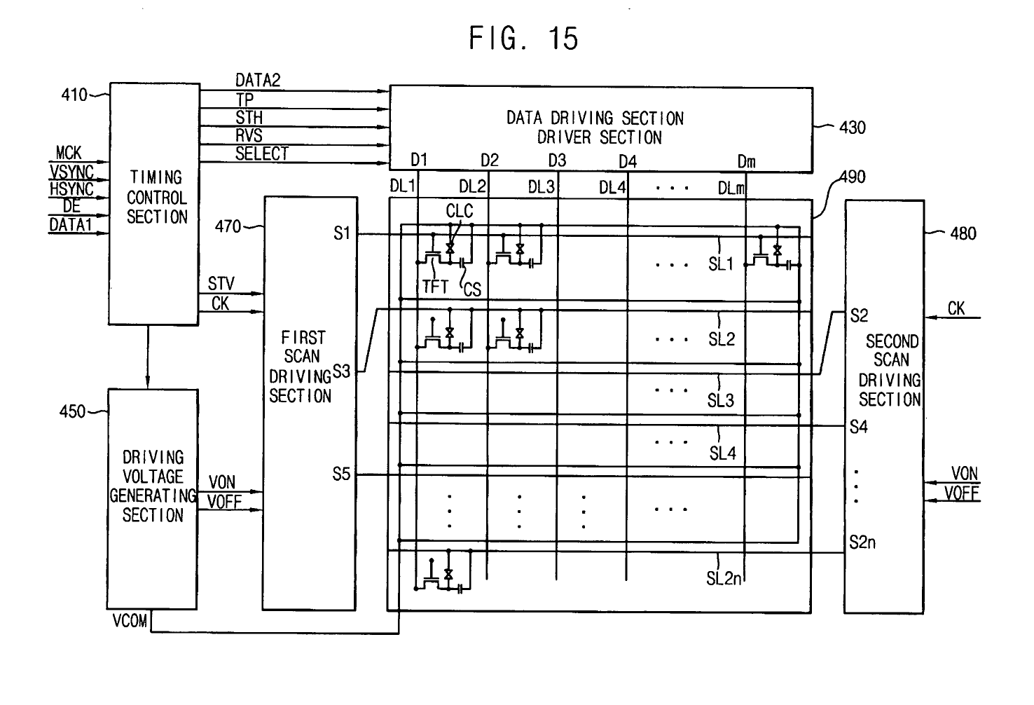

FIG. 15 is a schematic block diagram illustrating an LCD device according to another exemplary embodiment of the present invention. The embodiment of FIG. 15 is substantially similar to the embodiment of FIG. 12 and thus description of like elements will be omitted.

Referring to FIG. 15, an LCD device according to the present embodiment includes a timing control section 410, a data driving section 430, a driving voltage generating section 450, a first scan driving section 470, a second scan driving section 480 and an LCD panel 490.

The timing control section 410 converts a first data signal DATA1 provided from an external device (not shown) into a second data signal DATA2, and applies the second data signal DATA2 to the data driving section 430. The timing control section 410 also generates a second control signal, a third control signal and a fourth control signal, responsive to a first control signal provided from the external device.

The data driving section 430 converts the second data signal DATA2 into third data signals D1, D2, . . . , Dm corresponding to an analog signal, and applies the third data signals D1, D2, . . . , Dm to data lines DL1, DL2, . . . , DLm of the LCD panel 490. The data driving section 430 includes a latch for storing line data corresponding to at least two lines. The line data stored by the latch is selected by the selection signal SELECT of the second control signal, and converts the selected line data into a data signal corresponding to an analog signal. The line signal selected by the selection signal SELECT has an opposite level to a level of the common voltage VCOM.

Therefore, data signals corresponding to the (4K−3)-th and (4K−1)-th lines, which have the second level are outputted in sequence during a first 2H time period when the common voltage VCOM of the first level is outputted, and then data signals corresponding to the (4K−2)-th and 4K-th lines, which have the first level are outputted in sequence during a next 2H time period when the common voltage VCOM of the second level is outputted.

A block diagram illustrating the data driving section 430 of the present embodiment is substantially the same as that of the data driving section 333 in FIG. 13. Therefore, any further explanation will be omitted.

The driving voltage generating section 450 generates the first and second source voltages VOFF and VON, and the common voltage VCOM. The common voltage VCOM has a 4H time period.

The first and second scan driving sections 470 and 480 apply the scan signals S1, S2, . . . , S2n to corresponding ones of the scan lines SL1, SL2, . . . , SL2n, respectively. The first scan driving section 470 outputs odd numbered scan signals S1, S3, . . . S2n-1, and the second scan driving section 480 outputs even numbered scan signals S2, S4, . . . , S2n.

According to a 1-line inversion method by using the common voltage having a 4H time period, the (4K−3)-th scan line and the (4K−1)-th scan line are activated in sequence during the first 2H time period, and then the (4K−2)-th scan line and the 4K-th scan line are activated in sequence during the next 2H time period.

The LCD panel 490 includes a TFT substrate, a color filter substrate and a liquid crystal layer disposed between the TFT substrate and the color filter substrate. The TFT substrate includes the data lines DL1, DL2, . . . , DLm, and the scan lines SL1, SL2, . . . , SLn. Each of the data lines DL1, DL2, . . . , DLm is extended in a first direction, and each of the scan lines SL1, SL2, . . . , SLn is extended in a second direction that is substantially perpendicular to the first direction.

One of the data lines DL1, DL2, . . . , DLm and one of the scan lines SL1, SL2, . . . , SLn define a pixel, so that m×n (m times n) number of pixels are defined on the LCD panel 490. Each pixel includes a switching device such as a TFT, a liquid crystal capacitor CLC and a storage capacitor CS.

The TFT includes a gate electrode that is electrically connected to one of the scan lines SL1, SL2, . . . , SLn, a source electrode that is electrically connected to one of the data lines DL1, DL2, . . . , DLm, and a drain electrode that is electrically connected to a pixel electrode that corresponds to a first electrode of the liquid crystal capacitor CLC. The storage capacitor CS is defined by the gate electrode and the pixel electrode.

The color filter substrate includes color filters corresponding to the pixel electrode of the TFT substrate, and a common electrode that corresponds to a second electrode of the liquid crystal capacitor CLC.

The common voltage VCOM having the 4H time period is applied to the second electrode of the liquid crystal capacitor CLC and the common electrode of the storage capacitor CS.

A method of driving the LCD device according to the present embodiment is substantially the same as a method described in FIG. 14. Therefore, any further explanation will be omitted.

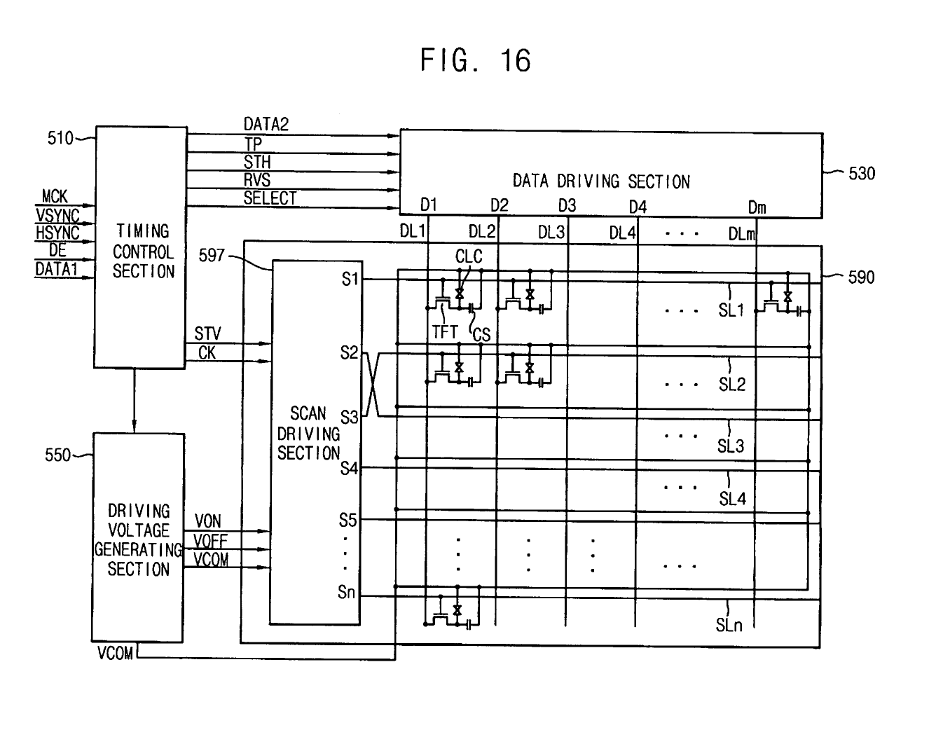

FIG. 16 is a schematic block diagram illustrating an LCD device according to still another exemplary embodiment of the present invention. The embodiment of FIG. 16 is substantially similar to the embodiments of FIGS. 12 and 15, thus description of like elements will be omitted.

Referring to FIG. 16, an LCD device according to the present embodiment includes a timing control section 510, a data driving section 530, a driving voltage generating section 550 and an LCD panel 590 having a scan driving section 597 formed therein.

The timing control section 510 converts a first image signal DATA1 provided is from an external device (not shown) into a second image signal DATA2, and applies the second image signal DATA2 to the data driving section 530. Additionally, the timing control section 510 generates a second control signal, a third control signal and a fourth control signal, responsive to the first control signal provided from the external device.

The data driving section 530 transforms the second image signal DATA2 into data signals D1, D2, . . . , Dm, responsive to the second control signal to apply the data signals D1, D2, . . . , Dm to data lines DL1, DL2, . . . , DLm. The data driving section 530 has a storing capacity for storing the second image signal DATA2 of two vertical lines. The data driving section 530 selects the second image signal DATA2 corresponding to specific lines, responsive to the selection signal SELECT. For example, the data driving section 530 selects the second image signal DATA2 having an inverted level with respect to the common voltage VCOM. The data driving section 530 outputs the data signal corresponding to the (4K−3)-th line and the (4K−1)-th line having the second level in sequence during a first 2H time period when the common voltage VCOM of the first level is outputted, and then outputs the data signal corresponding to the (4K−2)-th line and the 4K-th line having the first level in sequence during a next 2H time period when the common voltage VCOM of the second level is outputted. The data driving section 530 has substantially the same structure as described in FIG. 13. Therefore, any further explanation will be omitted.

The driving voltage generating section 550 generates the first and second source voltages VOFF and VON, and the common voltage VCOM. The common voltage VCOM has a 4H time period.

The LCD panel 590 includes a TFT substrate, a color filter substrate and a liquid crystal layer disposed between the TFT substrate and the color filter substrate. The TFT substrate includes the data lines DL1, DL2, . . . , DLm, the scan lines SL1, SL2, . . . , SLn, and the scan driving section 597. Each of the data lines DL1, DL2, . . . , DLm is extended in a first direction, and each of the scan lines SL1, SL2, . . . , SLn is extended in a second direction that is substantially perpendicular to the first direction.

One of the data lines DL1, DL2, . . . , DLm and one of the scan lines SL1, SL2, SLn define a pixel, so that m×n (m times n) number of pixels are defined on the LCD panel 590. Each pixel includes a switching device such as a TFT, a liquid crystal capacitor CLC and a storage capacitor CS.

The TFT includes a gate electrode that is electrically connected to one of the scan lines SL1, SL2, . . . , SLn, a source electrode that is electrically connected to one of the data lines DL1, DL2, . . . , DLm, and a drain electrode that is electrically connected to a pixel electrode that corresponds to a first electrode of the liquid crystal capacitor CLC. The storage capacitor CS is defined by the gate electrode and the pixel electrode.

The scan driving section 597 applies the scan signals S1, S2, . . . , Sn to the scan lines SL1, SL2, . . . , SLn of the display panel 190, respectively. According to a 1-line inversion by the common voltage VCOM having the 4H time period, scan signals for activating the (4K−3)-th and (4K−1)-th scan lines in sequence are outputted during the first 2H time period, and then scan signals for activating the (4K−2)-th and 4K-th scan lines in sequence during the next 2H time period.

The scan driving section 597 includes a first shift register having stages SRC1 through SRCn that are connected with each other as shown in FIG. 4. The scan driving section 597 is substantially the same as that in FIG. 4. Therefore, any further explanation will be omitted.

The color filter substrate includes color filters corresponding to the pixel electrode of the TFT substrate, and a common electrode that corresponds to a second electrode of the liquid crystal capacitor CLC.

The common voltage VCOM having the 4H time period is applied to the second electrode of the liquid crystal capacitor CLC and the common electrode of the storage capacitor CS.

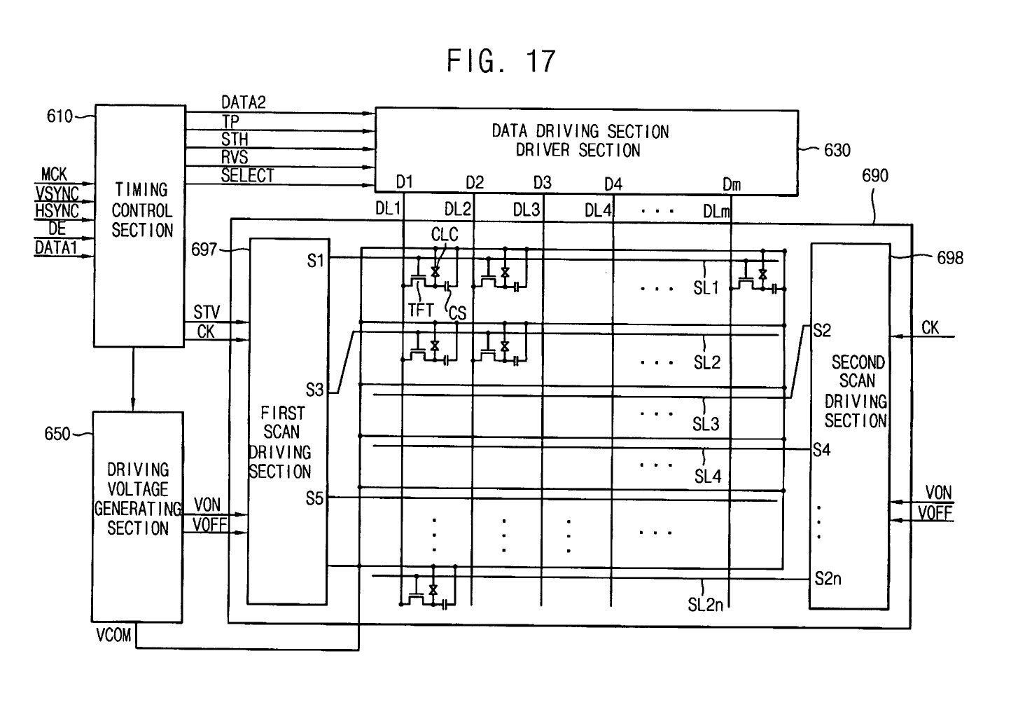

FIG. 17 is a schematic block diagram illustrating an LCD device according to still another exemplary embodiment of the present invention. The embodiment of FIG. 17 is substantially similar to the embodiments of FIG. 16 except for a second driving section, thus description of like elements will be omitted.

Referring to FIG. 17, an LCD device according to the present embodiment includes a timing control section 610, a data driving section 630, a driving voltage generating section 650 and an LCD panel 690 having a first scan driving section 697 and a second driving section 698 formed thereon.

The timing control section 610 converts a first data signal DATA1 provided from an external device (not shown) into a second data signal DATA2, and applies the second data signal DATA2 to the data driving section 630. The timing control section 610 also generates a second control signal, a third control signal and a fourth control signal, responsive to the first control signal provided from the external device.

The data driving section 630 converts the second data signal DATA2 into a third data signal including data signals D1, D2, . . . , Dm corresponding to an analog signal, and applies the third data signal to data lines DL1, DL2, . . . , DLm of the LCD panel 690. The data driving section 630 includes a latch for storing line data corresponding to at least two lines. The line data stored by the latch is selected by the selection signal SELECT of the second control signal, and converts the selected line data into a data signal corresponding to an analog signal. The line signal selected by the selection signal SELECT has an opposite level to a level of the common voltage VCOM.

Therefore, data signals corresponding to the (4K−3)-th and (4K−1)-th lines, which have the second level are outputted in sequence during a first 2H time period when the common voltage VCOM of the first level is outputted, and then data signals corresponding to the (4K−2)-th and 4K-th lines, which have the first level are outputted in sequence during a next 2H time period when the common voltage VCOM of the second level is outputted.

A block diagram illustrating the data driving section 630 of the present embodiment is substantially the same as that of the data driving section 330 in FIG. 13. Therefore, any further explanation will be omitted.

The driving voltage generating section 650 generates the first and second source voltages VOFF and VON, and the common voltage VCOM. The common voltage VCOM has a 4H time period.

The LCD panel 690 includes a TFT substrate, a color filter substrate and a liquid crystal layer disposed between the TFT substrate and the color filter substrate. The TFT substrate includes the data lines DL1, DL2, . . . , DLm, the scan lines SL1, SL2, . . . , SLn, the first scan driving section 697 and the second scan driving section 698. Each of the data lines DL1, DL2, . . . , DLm is extended in a first direction, and each of the scan lines SL1, SL2, . . . , SLn is extended in a second direction that is substantially perpendicular to the first direction.

One of the data lines DL1, DL2, . . . , DLm and one of the scan lines SL1, SL2, . . . , SLn define a pixel, so that m×n (m times n) number of pixels are defined on the LCD panel 690. Each pixel includes a switching device such as a TFT, a liquid crystal capacitor CLC and a storage capacitor CS.

The TFT includes a gate electrode that is electrically connected to one of the scan lines SL1, SL2, . . . , SLn, a source electrode that is electrically connected to one of the data lines DL1, DL2, . . . , DLm, and a drain electrode that is electrically connected to a pixel electrode that corresponds to a first electrode of the liquid crystal capacitor CLC. The storage capacitor CS is defined by the gate electrode and the pixel electrode.

The first and second scan driving sections 697 and 698 apply the scan signals S1, S2, . . . , S2n to corresponding ones of the scan lines SL1, SL2, . . . , SL2n, respectively. According to a 1-line inversion method by using the common voltage VCOM having the 4H time period, the first and second scan driving sections 697 and 698 activate the (4K−3)-th scan line and the (4K−1)-th scan line in sequence during a first 2H time period, and then the first and second scan driving sections 697 and 698 activate the (4K−2)-th scan line and the 4K-th scan line in sequence during a next 2H time period. The first scan driving section 697 includes the first shift register 251 having a plurality of stages SRC1, SRC3, . . . SRCD, and the second scan driving section 698 includes the second shift register 271 having a plurality of stages SRC2, SRC4, . . . , SRC2n as shown in FIG. 11. The first and second shift registers 251 and 271 are substantially the same as that in FIG. 11. Therefore, any further explanation will be omitted.

The color filter substrate includes color filters corresponding to the pixel electrode of the TFT substrate, and a common electrode that corresponds to a second electrode of the liquid crystal capacitor CLC.

The common voltage VCOM having the 4H time period is applied to the second electrode of the liquid crystal capacitor CLC and the common electrode of the storage capacitor CS.

A method of driving the LCD device according to the present embodiment is substantially the same as a method described in FIG. 14. Therefore, any further explanation will be omitted.

According to the present invention, a 1-line inversion may be accomplished by using a common voltage having a 4H time period to reduce power consumption of a display device in comparison with a conventional 1-line inversion using a common voltage having a 2H inversion. Especially, an LCD device according to the present invention is more useful, when the LCD device is employed by a portable device that is operated by a battery, such as a notebook computer, etc.

Having described the exemplary embodiments of the present invention and its advantages, it is noted that various changes, substitutions and alterations can be made herein without departing from the spirit and scope of the invention as defined by appended claims.

What is claimed is:

1. A thin film transistor (TFT) substrate comprising:
data lines extending along a first direction;
scan lines extending along a second direction that is substantially perpendicular to the first direction;
pixels defined by a selected data line and a selected scan line and having a switching device electrically connected to the selected data line and the selected scan line; and
a shift register having stages electrically coupled with each other, and an output terminal of a (4K−3)-th stage being electrically connected to a (4K−3)-th scan line, an output terminal of a (4K−2)-th stage being electrically connected to a (4K−1)-th scan line, an output terminal of a (4K−1)-th stage being electrically connected to a (4K−2)-th scan line, and a 4K-th stage being electrically connected to a 4K-th scan line, wherein ‘K’ represents a natural number.

2. The TFT substrate of claim 1, wherein the switching device includes a source electrode electrically connected to one of the data lines, and a gate electrode electrically connected to one of the scan lines, and the switching device corresponds to an amorphous silicon TFT.

3. The TFT substrate of claim 2, wherein the shift register comprises amorphous silicon TFTs.

4. The TFT substrate of claim 1, wherein the shift register comprises a first sub-shift register having stages outputting odd numbered scan signals, and a second sub-shift register having stages outputting even numbered scan signals, the output terminal of the (4K−3)-th stage of the first sub-shift register is electrically connected to the (4K−3)-th scan line, the output terminal of a (4K−1)-th stage of the first sub-shift register is electrically connected to the (4K−2)-th scan line, the output terminal of a (4K−2)-th stage of the second sub-shift register is electrically connected to the (4K−1)-th scan line, and the 4K-th stage of the second sub-shift register is electrically connected to the 4K-th scan line.

5. The TFT substrate of claim 4, wherein the first sub-shift register is disposed at a first end portion of the scan lines, and the second sub-shift register is disposed at a second end portion of the scan lines.

6. A display device comprising:
a display section including data lines, scan lines, a switching device electrically connected to one of the data lines and one of the scan lines, and a liquid crystal capacitor having a first terminal electrically connected to the switching device and a second terminal receiving a common voltage;
a voltage generating section outputting the common voltage having a first level during a first time period, and outputting the common voltage having a second level during a second time period;
a first driving section applying data signals corresponding to a (4K−3)-th scan line and a (4K−1)-th scan line in sequence during the first time period, and applying data signals corresponding to a (4K−2)-th scan line and a 4K-th scan line in sequence during the second time period; and
a second driving section outputting scan signals activating the (4K−3)-th scan line and the (4K−1)-th scan line in sequence and then outputting scan signals activating the (4K−2)-th scan line and the 4K-th scan line in sequence, wherein ‘K’ represents a natural number.

7. The display device of claim 6, wherein the display section further comprises a storage capacitor having a first terminal electrically connected to the first terminal of the liquid crystal capacitor, and a second terminal receiving the common voltage.

8. The display device of claim 6, wherein the first driving section comprises:
a storing part configured to store a first image signal provided from an external device;
a control part configured to control the storing part to store the first image signal, and configured to read the first image signal having a reference level that is is opposite to a level of the common voltage to convert the first image signal into a second image signal; and
a data driving part converting the second image signal into an analog signal to apply the analog signal to the data lines.

9. The display device of claim 8, wherein the data driving part comprises:
a shift register outputting a latch signal;
a dot latch configured to latch the second image signal by a dot unit, and configured to output the second image signal when the latch signal is applied to the dot latch;
a line latch configured to latch the second image signal by a line unit, and configured to output the second image signal when a load signal is applied to the line latch; and
a digital to analog converter configured to convert the second image signal into the analog signal responsive to the reference level.

10. The display device of claim 6, wherein the first driving section comprises:
a shift register outputting a latch signal;
a dot latch configured to latch a first image signal provided from an external device by a dot unit, and configured to output the first image signal when the latch signal is applied to the dot latch;
a line latch configured to latch the first image signal by a line unit, and configured to output a second image signal having a reference level that is opposite to a level of the common voltage; and
a digital to analog converter configured to convert the second image signal into the analog signal responsive to the reference level.

11. The display device of claim 6, wherein the second driving section comprises a shift register including:
a first stage receiving one of a scan start signal and a start signal outputted from a previous stage and applying a first output signal to a (4K−3)-th scan line;
a second stage receiving the first output signal and applying a second output signal to a (4K−1)-th scan line;
a third stage receiving the second output signal and applying a third output signal to a (4K−2)-th scan line; and
a fourth stage receiving the third output signal and applying a fourth output signal to a 4K-th scan line.

12. The display device of claim 6, wherein the second driving section comprises a first sub-scan driving section outputting odd numbered scan signals and a second sub-scan driving section outputting even numbered scan signals.

13. The display device of claim 12, wherein the first and second sub-scan driving sections comprise a first shift register and a second shift register, respectively, wherein the first shift register comprises:
a first stage receiving one of a scan start signal and a start signal outputted from a previous stage and applying a first output signal to a (4K−3)-th scan line; and
a third stage receiving a second output signal and applying a third output signal to a (4K−2)-th scan line, and the second shift register comprises:
a second stage receiving the first output signal and applying the second output signal to a (4K−1)-th scan line; and
a fourth stage receiving the third output signal and applying an output signal to a 4K-th scan line.

14. A driver device configured to drive a display device having data lines, scan lines, a switching device electrically connected to one of the data lines and one of the scan lines, and a liquid crystal capacitor having a first terminal electrically connected to the switching device and a second terminal receiving a common voltage, comprising:
a voltage generating section outputting the common voltage having a first level during a first time period, and outputting the common voltage having a second level during a second time period;
a first driving section applying data signals corresponding to a (4K−3)-th scan line and a (4K−1)-th scan line in sequence during the first time period, and applying data signals corresponding to a (4K−2)-th scan line and a 4K-th scan line in sequence during the second time period; and
a second driving section outputting scan signals activating the (4K−3)-th scan line and the (4K−1)-th scan line in sequence and then outputting scan signals activating the (4K−2)-th scan line and the 4K-th scan line in sequence, wherein ‘K’ represents a natural number.

15. The driver device of claim 14, wherein the display device further comprises a storage capacitor having a first terminal that is electrically connected to the first terminal of the liquid crystal capacitor, and a second terminal receiving the common voltage.

16. The driver device of claim 14, wherein the first driving section comprises:
a storing part configured to store a first image signal provided from an external device;
a control part configured to control the storing part to store the first image signal, and configured to read the first image signal having a reference level that is opposite to a level of the common voltage to convert the first image signal into a second image signal; and
a data driving part converting the second image signal into an analog signal to apply the analog signal to the data lines.

17. The driver device of claim 16, wherein the data driving part comprises:
a shift register outputting a latch signal;
a dot latch configured to latch the second image signal by a dot unit, and configured to output the second image signal when the latch signal is applied to the dot latch;
a line latch configured to latch the second image signal by a line unit, and configured to output the second image signal when a load signal is applied to the line latch; and
a digital to analog converter configured to convert the second image signal into the analog signal responsive to the reference level.

18. The driver device of claim 14, wherein the first driving section comprises:
a shift register outputting a latch signal;
a dot latch configured to latch a first image signal provided from an external device by a dot unit, and configured to output the first image signal when the latch signal is applied to the dot latch;
a line latch configured to latch the first image signal by a line unit, and configured to output a second image signal having a reference level that is opposite to a level of the common voltage; and
a digital to analog converter configured to convert the second image signal into the analog signal, responsive to the reference level.

19. The driver device of claim 14, wherein the second driving section comprises a shift register including:
a first stage receiving one of a scan start signal and a start signal outputted from a previous stage and applying a first output signal to a (4K−3)-th scan line;
a second stage receiving the first output signal and applying a second output signal to a (4K−1)-th scan line;
a third stage receiving the second output signal and applying a third output signal to a (4K−2)-th scan line; and
a fourth stage receiving the third output signal and applying a fourth output signal to a 4K-th scan line.

20. The driver display device of claim 14, wherein the second driving section comprises a first sub-scan driving section outputting odd numbered scan signals and a second sub-scan driving section outputting even numbered scan signals.

21. The driver display device of claim 20, wherein the first and second sub-scan driving sections comprise a first shift register and a second shift register, respectively, wherein the first shift register comprises:
a first stage receiving one of a scan start signal and a start signal outputted from a previous stage and applying a first output signal to a (4K−3)-th scan line; and
a third stage receiving a second output signal and applying a third output signal to a (4K−2)-th scan line, and
the second shift register comprises:
a second stage receiving the first output signal and applying the second output signal to a (4K−1)-th scan line; and
a fourth stage receiving the third output signal and applying a fourth output signal to a 4K-th scan line.

22. A method for driving a display device having data lines, scan lines, a switching device electrically connected to one of the data lines and one of the scan lines, and a liquid crystal capacitor having a first terminal electrically connected to the switching device and a second terminal, the method comprising:
activating a (4K−3)-th scan line and a (4K−1)-th scan line in sequence while applying a data signal having a reference level corresponding to a second level that is opposite to a first level to the data lines during a first time period when a common voltage having the first level is applied to the second terminal of the liquid crystal capacitor; and
activating a (4K−2)-th scan line and a 4K-th scan line in sequence while applying a data signal having a reference level corresponding to the first level to the data lines during a second time period when a common voltage having the second level is applied to the second terminal of the liquid crystal capacitor.

23. The method of claim 22, wherein the activating the (4K−3)-th scan line comprises applying a (4K−3)-th scan signal to the (4K−3)-th scan line, and the activating the (4K−1)-th scan line comprises applying a (4K−2)-th scan signal to the (4K−1)-th scan line.

24. The method of claim 22, wherein the activating the (4K−2)-th scan line comprises applying a (4K−1)-th scan signal to the (4K−2)-th scan line, and the activating the 4K-th scan line comprises applying a 4K-th scan signal to the 4K-th scan line.

25. The method of claim 22, wherein the activating the (4K−3)-th scan line and the (4K−1)-th scan line in sequence comprises:
storing first image signals provided from an external device;
reading one of the first image signals which have a reference level that is opposite to the common voltage, to convert the one of the first image signals into a second image signal; and
converting the second image signal into an analog signal to apply the analog signal to one of the data lines.

26. The method of claim 22, wherein the activating the (4K−2)-th scan line and the 4K-th scan line in sequence comprises:
storing first image signals provided from an external device;
reading one of the first image signals which have a reference level that is opposite to the common voltage, to convert the one of the first image signals into a second image signal; and
converting the second image signal into an analog signal to apply the analog signal to one of the data lines.

27. The method of claim 25, wherein the converting the second image signal into the analog signal comprises:
outputting a latch signal;
latching the second image signal by a dot unit;
outputting the second image signal that is latched by the dot unit in response to the latch pulse;
latching the second image signal by a line unit;
outputting the second image signal that is latched by a line unit in response to a load signal; and
converting the second image signal into a data signal corresponding to an analog signal.

28. The method of claim 26, wherein the converting the second image signal into the analog signal comprises:
outputting a latch signal;
latching the second image signal by a dot unit;
outputting the second image signal that is latched by the dot unit in response to the latch pulse;
latching the second image signal by a line unit;
outputting the second image signal that is latched by a line unit in response to a load signal; and
converting the second image signal into a data signal corresponding to an analog signal.

29. A method for driving a display device having data lines, scan lines, a switching device electrically connected to one of the data lines and one of the scan lines, and a liquid crystal capacitor having a first terminal electrically connected to the switching device and a second terminal, comprising:
applying a common voltage having a 4H time period to the second terminal of the liquid crystal capacitor, H corresponding to a time period for activating one of the scan lines;
applying a data signal having a reference level corresponding to a second level that is opposite to a first level to the data lines during a first 2H time period when the common voltage has the first level;
activating a (4K−3)-th scan line and a (4K−1)-th scan line in sequence during the first 2H time period;
applying a data signal having a reference level corresponding to the first level to the data lines during a second 2H time period when the common voltage has the second level; and
activating a (4K−2)-th scan line and a 4K-th scan line in sequence during the first 2H time period, wherein ‘K’ represents a natural number.

30. The method of claim 29, wherein the activating the (4K−3)-th scan line comprises applying a (4K−3)-th scan signal to the (4K−3)-th scan line, and the activating the (4K−1)-th scan line comprises applying a (4K−2)-th scan signal to the (4K−1)-th scan line.

31. The method of claim 29, wherein the activating the (4K−2)-th scan is line comprises applying a (4K−1)-th scan signal to the (4K−2)-th scan line, and the activating the 4K-th scan line comprises applying a 4K-th scan signal to the 4K-th scan line.

32. The method of claim 29, wherein a data signal having a positive polarity is applied to the first terminal of the liquid crystal capacitor, which corresponds to the (4K−3)-th and (4K−1)-th scan lines, and the common voltage having a negative polarity is applied to the second terminal of the liquid crystal capacitor during the first 2H time period.

33. The method of claim 29, wherein a data signal having a negative polarity is applied to the first terminal of the liquid crystal capacitor, which corresponds to the (4K−3)-th and (4K−1)-th scan lines, and the common voltage having a positive polarity is applied to the second terminal of the liquid crystal capacitor during the second 2H time period.

34. The method of claim 29, wherein a data signal having a negative polarity is applied to the first terminal of the liquid crystal capacitor, which corresponds to the (4K−2)-th and 4K-th scan lines, and the common voltage having a positive polarity is applied to the second terminal of the liquid crystal capacitor during the first 2H time period.

35. The method of claim 29, wherein a data signal having a positive polarity is applied to the first terminal of the liquid crystal capacitor, which corresponds to the (4K−2)-th and 4K-th scan lines, and the common voltage having a negative polarity is applied to the second terminal of the liquid crystal capacitor during the second 2H time period.
